(19) United States
(12) Patent Application Publication
(10) Pub. No.: US 2026/0029653 A1
(43) Pub. Date: Jan. 29, 2026

(54) Smart Glasses with a Movable Micromirror Array (MMA)Which Enables a Real Word Viewing Mode, a Virtual Reality Viewing Mode,and an Augmented Reality Viewing Mode

(71) Applicant: Robert A. Connor, Wyoming, MN (US)

(72) Inventor: Robert A. Connor, Wyoming, MN (US)

(73) Assignee: Holovisions LLC, Ham Lake, MN (US)

(21) Appl. No.: 19/347,028

(22) Filed: Oct. 1, 2025

Related U.S. Application Data
(63) Continuation-in-part of application No. 19/069,077, filed on Mar. 3, 2025.
(63) Continuation-in-part of application No. 18/827,703, filed on Sep. 7, 2024, now Pat. No. 12,436,394.
(63) Continuation-in-part of application No. 18/800,091, filed on Aug. 11, 2024.
Application No. 19/069,077 is a continuation-in-part of application No. 18/827,703, filed on Sep. 7, 2024, now Pat. No. 12,436,394.
Application No. 18/827,703 is a continuation-in-part of application No. 18/800,091, filed on Aug. 11, 2024.
Application No. 18/827,703 is a continuation-in-part of application No. 18/800,091, filed on Aug. 11, 2024.
Application No. 18/800,091 is a continuation-in-part of application No. 18/586,439, filed on Feb. 24, 2024, now Pat. No. 12,205,231.
Application No. 18/800,091 is a continuation-in-part of application No. 18/586,439, filed on Feb. 24, 2024, now Pat. No. 12,205,231.
Application No. 18/586,439 is a continuation-in-part of application No. 18/088,548, filed on Dec. 24, 2022, now Pat. No. 12,013,538.
Application No. 18/088,548 is a continuation-in-part of application No. 17/722,354, filed on Apr. 17, 2022, now Pat. No. 11,754,843.
Application No. 17/722,354 is a continuation-in-part of application No. 17/501,495, filed on Oct. 14, 2021, now Pat. No. 11,307,420.
Application No. 17/501,495 is a continuation-in-part of application No. 16/686,170, filed on Nov. 17, 2019, now Pat. No. 11,163,163.
Application No. 16/686,170 is a continuation-in-part of application No. 16/175,924, filed on Oct. 31, 2018, now Pat. No. 10,859,834.
Application No. 16/175,924 is a continuation-in-part of application No. 15/942,498, filed on Mar. 31, 2018, now Pat. No. 10,338,400.
(60) Provisional application No. 62/624,699, filed on Jan. 31, 2018.
(60) Provisional application No. 62/624,699, filed on Jan. 31, 2018.
(60) Provisional application No. 62/638,087, filed on Mar. 3, 2018.
(60) Provisional application No. 62/638,087, filed on Mar. 3, 2018.
(60) Provisional application No. 62/646,856, filed on Mar. 22, 2018.
(60) Provisional application No. 62/646,856, filed on Mar. 22, 2018.
(60) Provisional application No. 62/695,124, filed on Jul. 8, 2018.
(60) Provisional application No. 62/699,800, filed on Jul. 18, 2018.
(60) Provisional application No. 62/703,025, filed on Jul. 25, 2018.
(60) Provisional application No. 62/714,684, filed on Aug. 4, 2018.
(60) Provisional application No. 62/716,507, filed on Aug. 9, 2018.
(60) Provisional application No. 62/720,171, filed on Aug. 21, 2018.
(60) Provisional application No. 62/746,487, filed on Oct. 16, 2018.
(60) Provisional application No. 62/749,775, filed on Oct. 24, 2018.
(60) Provisional application No. 62/751,076, filed on Oct. 26, 2018.
(60) Provisional application No. 62/791,359, filed on Jan. 11, 2019.
(60) Provisional application No. 63/192,664, filed on May 25, 2021.
(60) Provisional application No. 63/212,054, filed on Jun. 17, 2021.

(51) Int. Cl. G02B 27/01

(52) U.S. Cl. CPC G02B 27/0176; G02B 27/0172; G02B 2027/0154; G02B 2027/0178

(57) ABSTRACT

This invention is augmented reality eyewear which can transition between a real world viewing mode, a virtual reality viewing mode, and an augmented reality viewing mode. This eyewear shows bright opaque virtual objects in a portion of a person's field of view while providing the person with a clear view of the real world in the rest of their field of view. This eyewear includes an eyewear frame, an optical display, a lens, a plurality of selectively-movable (pivoting or rotating) micromirrors, and an array of electroconductive pathways.

### CROSS-REFERENCE TO RELATED APPLICATIONS

This application is a continuation-in-part of U.S. patent application Ser. No. 19/069,077 filed on 2025 Mar. 3. This application is a continuation-in-part of U.S. patent application Ser. No. 18/827,703 filed on 2024 Sep. 7. This application is a continuation-in-part of U.S. patent application Ser. No. 18/800,091 filed on 2024 Aug. 11. U.S. patent application Ser. No. 19/069,077 was a continuation-in-part of U.S. patent application Ser. No. 18/827,703 filed on 2024 Sep. 7. U.S. patent application Ser. No. 19/069,077 was a continuation-in-part of U.S. patent application Ser. No. 18/800,091 filed on 2024 Aug. 11.

U.S. patent application Ser. No. 18/827,703 was a continuation-in-part of U.S. patent application Ser. No. 18/800,091 filed on 2024 Aug. 11. U.S. patent application Ser. No. 18/827,703 was a continuation-in-part of U.S. patent application Ser. No. 18/586,439 filed on 2024 Feb. 24. U.S. patent application Ser. No. 18/800,091 was a continuation-in-part of U.S. patent application Ser. No. 18/586,439 filed on 2024 Feb. 24. U.S. patent application Ser. No. 18/586,439 was a continuation-in-part of U.S. patent application Ser. No. 18/088,548 filed on 2022 Dec. 24. U.S. patent application Ser. No. 18/088,548 was a continuation-in-part of U.S. patent application Ser. No. 17/722,354 filed on 2022 Apr. 17. U.S. patent application Ser. No. 17/722,354 was a continuation-in-part of U.S. patent application Ser. No. 17/501,495 filed on 2021 Oct. 14.

U.S. patent application Ser. No. 17/501,495 was a continuation-in-part of U.S. patent application Ser. No. 16/686,170 filed on 2019 Nov. 17. U.S. patent application Ser. No. 17/501,495 claimed the priority benefit of U.S. provisional patent application 63/192,664 filed on 2021 May 25. U.S. patent application Ser. No. 17/501,495 claimed the priority benefit of U.S. provisional patent application 63/212,054 filed on 2021 Jun. 17. U.S. patent application Ser. No. 16/686,170 claimed the priority benefit of U.S. provisional patent application 62/791,359 filed on 2019 Jan. 11. U.S. patent application Ser. No. 16/686,170 was a continuation-in-part of U.S. patent application Ser. No. 16/175,924 filed on 2018 Oct. 31 which issued as U.S. Pat. No. 10,859,834 on 2020 Dec. 8.

U.S. patent application Ser. No. 16/175,924 claimed the priority benefit of U.S. provisional patent application 62/751,076 filed on 2018 Oct. 26. U.S. patent application Ser. No. 16/175,924 claimed the priority benefit of U.S. provisional patent application 62/749,775 filed on 2018 Oct. 24. U.S. patent application Ser. No. 16/175,924 claimed the priority benefit of U.S. provisional patent application 62/746,487 filed on 2018 Oct. 16. U.S. patent application Ser. No. 16/175,924 claimed the priority benefit of U.S. provisional patent application 62/720,171 filed on 2018 Aug. 21. U.S. patent application Ser. No. 16/175,924 claimed the priority benefit of U.S. provisional patent application 62/716,507 filed on 2018 Aug. 9. U.S. patent application Ser. No. 16/175,924 claimed the priority benefit of U.S. provisional patent application 62/714,684 filed on 2018 Aug. 4. U.S. patent application Ser. No. 16/175,924 claimed the priority benefit of U.S. provisional patent application 62/703,025 filed on 2018 Jul. 25. U.S. patent application Ser. No. 16/175,924 claimed the priority benefit of U.S. provisional patent application 62/699,800 filed on 2018 Jul. 18. U.S. patent application Ser. No. 16/175,924 claimed the priority benefit of U.S. provisional patent application 62/695,124 filed on 2018 Jul. 8. U.S. patent application Ser. No. 16/175,924 was a continuation-in-part of U.S. patent application Ser. No. 15/942,498 filed on 2018 Mar. 31 which issued as U.S. Pat. Nos. 10,859,834 10,338,400 on 2019 Jul. 2. U.S. patent application Ser. No. 16/175,924 claimed the priority benefit of U.S. provisional patent application 62/646,856 filed on 2018 Mar. 22. U.S. patent application Ser. No. 16/175,924 claimed the priority benefit of U.S. provisional patent application 62/638,087 filed on 2018 Mar. 3. U.S. patent application Ser. No. 16/175,924 claimed the priority benefit of U.S. provisional patent application 62/624,699 filed on 2018 Jan. 31.

U.S. patent application Ser. No. 15/942,498 claimed the priority benefit of U.S. provisional patent application 62/646,856 filed on 2018 Mar. 22. U.S. patent application Ser. No. 15/942,498 claimed the priority benefit of U.S. provisional patent application 62/638,087 filed on 2018 Mar. 3. U.S. patent application Ser. No. 15/942,498 claimed the priority benefit of U.S. provisional patent application 62/624,699 filed on 2018 Jan. 31. U.S. patent application Ser. No. 15/942,498 claimed the priority benefit of U.S. provisional patent application 62/572,328 filed on 2017 Oct. 13. U.S. patent application Ser. No. 15/942,498 claimed the priority benefit of U.S. provisional patent application 62/563,798 filed on 2017 Sep. 27. U.S. patent application Ser. No. 15/942,498 claimed the priority benefit of U.S. provisional patent application 62/561,834 filed on 2017 Sep. 22. U.S. patent application Ser. No. 15/942,498 claimed the priority benefit of U.S. provisional patent application 62/528,331 filed on 2017 Jul. 3.

The entire contents of these related applications are incorporated herein by reference.

### FEDERALLY SPONSORED RESEARCH

Not Applicable

### SEQUENCE LISTING OR PROGRAM

Not Applicable

### BACKGROUND—FIELD OF INVENTION

This invention relates to augmented reality eyewear.

### INTRODUCTION

Augmented Reality (AR) eyewear allows a person to simultaneously see their environment and virtual objects displayed in their field of vision. Augmented Reality (also called “Mixed Reality”) can include simulated interactions between a person and virtual objects in their environment. Augmented reality has numerous potential applications in the fields of commerce and shopping, defense, diet and nutritional improvement, education, engineering, entertainment, exploration, gaming, interior design, maintenance, manufacturing, medicine, movies, navigation and transportation, public safety, socializing, and sports. Although there is considerable potential for augmented reality, there are also substantive challenges. One of the challenges is how to display bright opaque virtual objects in a portion of a person's field of view while also providing a clear view of the real world in the rest of the person's field of view. This challenge is addressed by the invention disclosed herein.

### REVIEW OF THE RELEVANT ART

U.S. patent application publication 20190025688 (Maynard, Jan. 24, 2019, “Immersive Optical Projection System”) discloses an optical system with a miniature array of projectors which are geometrically arranged to cover photoreceptive areas of the retina. U.S. patent application publication 20200400943 (Kessler et al., Dec. 24, 2020, “Wearable Display for Near-to-Eye Viewing with Expanded Beam”) discloses an optical apparatus with a laser light source sending a modulated beam toward a scan mirror. U.S. Pat. No. 11,122,256 (Topliss et al., Sep. 14, 2021, “Mixed Reality System”) discloses a mixed reality retinal projector system that uses a reflective holographic combiner to direct light from a light engine into an eye box.

U.S. patent application publications 20210382312 (Freeman et al., Dec. 9, 2021, “Wearable Image Manipulation and Control System with High Resolution Micro-Displays and Dynamic Opacity Augmentation in Augmented Reality Glasses”) and 20210389590 (Freeman et al., Dec. 16, 2021, “Wearable Image Manipulation and Control System with High Resolution Micro-Displays and Dynamic Opacity Augmentation in Augmented Reality Glasses”) disclose a mixed reality display comprising: at least one lens, where the lens has a reflective element and a plurality of pixels; at least one display capable of projecting images onto at least a portion of the one lens; and a dynamic opacity system, where the dynamic opacity system is capable of making at least one pixel opaque in the portion of the lens onto which the one or more images are projected, while the rest of the lens remains see-through.

U.S. patent application publication 20220043323 (Skirlo et al., Feb. 10, 2022, “Methods and Systems for Optical Beam Steering”) discloses an integrated optical beam steering device with a planar dielectric lens that collimates beams from different inputs in different directions. U.S. patent application publication 20220082836 (Qin, Mar. 17, 2022, “Thin Near-To-Eye Display Device with Large Field of View Angle”) discloses a thin near-to-eye display device with a large field of view angle. U.S. patent application publication 20230360567 (Yang, Nov. 9, 2023, “Virtual Reality Display System”) discloses a near-eye display device with, a camera to track the location of an eye pupil center, a projection light source to provide a collimated beam, and a micromirror array with adjustable micromirror pixels. U.S. patent application publication 20240012255 (Toy et al., Jan. 11, 2024, “Optical Assemblies, Head-Mounted Displays, and Related Methods”) discloses optical assemblies with at least one light subprojector.

U.S. patent application publication 20240027748 (Greif et al., Jan. 25, 2024, “Scanning Projector Performing Consecutive Non-Linear Scan with Multi-Ridge Light Sources”) discloses a scanning projector in a near-eye display device which is coupled to a waveguide and includes a multi-ridge light source. U.S. patent application publication 20240036342 (Ouderkirk et al., Feb. 1, 2024, “Reflective Fresnel Folded Optic Display”) discloses an apparatus may with a display, a first lens assembly including a lens and a reflector, and a second lens assembly including a second lens and a second reflector, wherein the first lens assembly includes a Fresnel surface. U.S. patent application publications 20240053818 (Cross et al., Feb. 15, 2024, “Reconfigurable Headset That Transitions Between Virtual Reality, Augmented Reality, and Actual Reality”) and 20250216929 (Cross et al., Jul. 3, 2025, “Reconfigurable Headset That Transitions Between Virtual Reality, Augmented Reality, and Actual Reality”) disclose a method for identifying when to switch an enhanced reality headset between a virtual reality configuration, an augmented reality configuration, and a direct reality configuration.

U.S. patent application publication 20240061246 (Huang et al., Feb. 22, 2024, “Light Field Directional Backlighting Based Three-Dimensional (3D) Pupil Steering”) discloses a head-mounted display device employing light field directional backlighting to provide three-dimensional (3D) pupil steering without mechanical adjustment. U.S. patent application publication 20240094584 (Feng et al., Mar. 21, 2024, “Optical Dimming Devices with Chiral Ferroelectric Nematic Liquid Crystal”) discloses an optical device with a first electrode and a medium that includes ferroelectric liquid crystals and chiral dopants, wherein the optical device is used as an optical dimming device. U.S. patent application publication 20240094611 (Jolly et al., Mar. 21, 2024, “Optical Modulator and Image Projector Based on Leaky-Mode Waveguide with Temporal Multiplexing”) discloses a leaky-mode acousto-optical modulator for generating visual images.

U.S. patent application publication 20240103271 (Seisan, Mar. 28, 2024, “Opacity Control of Augmented Reality Devices”) discloses an augmented reality (AR) eyewear device with a lens system including an optical screening mechanism that enables switching the lens system between a conventional see-through state and an opaque state. U.S. patent application publication 20240151996 (Purvis et al., May 9, 2024, “Chiral Organic Optoelectronic Molecules for Improved Refractive Index Modulation in Active Optical Devices”) discloses an Organic Solid Crystal (OSC) thin film with an organic crystalline phase, where the organic crystalline phase includes a chiral molecule. U.S. patent application publication 20240150935 (Purvis et al., May 9, 2024, “Chiral Organic Optoelectronic Molecules with Tunable Refractive Index for Improved Control of Circularly Polarized Light Propagation in Optical Devices”) discloses a layer of molecular feedstock over a surface of a substrate, wherein the molecular feedstock includes a chiral molecule.

U.S. patent application publication 20240151993 (Purvis et al., May 9, 2024, “Electron Withdrawing Group (EWG)-Containing Organic Molecules for Improved Optical Properties in AR/VR Components”) discloses an optical modulator with an organic solid crystal thin film having an organic molecule and an electron withdrawing group (EWG) bonded to the organic molecule, a primary electrode disposed over a first region of the organic solid crystal thin film, and a secondary electrode disposed over a second region of the organic solid crystal thin film. U.S. patent application publication 20240168694 (Kim et al., May 23, 2024, “Display Device, and Wearable Device Including the Same”) discloses a display device may with at least one display panel comprising multiple subsidiary display panels.

U.S. patent application publication 20240192529 (Oh et al., Jun. 13, 2024, “Spatially-Patterned Switchable LC Waveplates for a Wide Viewing Aperture”) discloses a switchable waveplate with a substrate, a first electrode layer on the substrate, an alignment layer on the first electrode layer and including alignment patterns formed thereon, a liquid crystal layer on the alignment layer, and a second electrode layer on the liquid crystal layer. U.S. patent application publication 20240288695 (Friedman et al., Aug. 29, 2024, “Holographic Optical Element Viewfinder”) discloses a transparent combining optic including a holographic optical element. U.S. patent application publication 20240288694 (Friedman et al., Aug. 29, 2024, “Holographic Optical Element Viewfinder”) discloses at least one illumination source emitting light on a display and a transparent combining optic including a holographic optical element (HOE).

U.S. patent application publication 20240295763 (Diest et al., Sep. 5, 2024, “Advanced Optical Materials and Structures”) discloses a pair of electrodes and a dynamic material disposed between the pair of electrodes, wherein the dynamic material include a crystalline microstructure which changes between at least two states in response to a change in an electric field between the two electrodes. U.S. patent application publication 20240372978 (Sorahana, Nov. 7, 2024, “Display Apparatus and Display Method”) discloses a display apparatus that can display, without restricting the field of view, a three-dimensional image at a high resolution with a high degree of reproducibility in depth.

U.S. patent application publication 20240377693 (Sears et al., Nov. 14, 2024, “Optical Devices and Methods for Adjustable Light Attenuation Based on Anisotropic Materials”) discloses an optical device comprising: a first set of electrodes; a second set of electrodes distinct and separate from the first set of electrodes; and a medium located between the first set of electrodes and the second set of electrodes, wherein the medium includes a mixture of liquid crystals and magnetic microstructures. U.S. patent application publication 20240377691 (Sears et al., Nov. 14, 2024, “Optical Devices and Methods for Adjustable Light Attenuation Based on Optical Scattering”) discloses an optical device with an optically dimmable filter for providing a first set of scattering properties while the optically dimmable filter is in a first state and providing a second set of scattering properties while the first optically dimmable filter is in a second state.

U.S. patent application publication 20240393589 (Blum et al., Nov. 28, 2024, “See-Through Near Eye Optical Module”) discloses a see-through transparent (or semi-transparent) near eye optical module with a transparent sparsely populated near eye display comprising a plurality of pixels or pixel patches and a sparsely populated micro-lens array comprising a plurality of micro-lenses positioned in optical alignment with the pixels or pixel patches. U.S. patent application publication 20240411052 (Brongersma et al., Dec. 12, 2024, “Metasurface Optofluidics for Reflective Displays Integrated on Transparent Substrate”) discloses a geometric-phase metasurface combined with a fluidic circuit for tuning the properties of the metasurface.

U.S. patent application publication 20250013044 (De Matos et al., Jan. 9, 2025, “Head-Wearable Display Device”) discloses a head-wearable display device comprising: a transparent see-through area; a plurality of more than two display segments to emit sub-image portions of a display image; and a collimating optical system. U.S. patent application publication 20250040412 (Peng et al., Jan. 30, 2025, “Display Panel and Near-Eye Display Apparatus”) discloses a display panel with a central display region and an angle-customized display region surrounding the central display region. U.S. patent application publication 20250036201 (Zimmerman et al., Jan. 30, 2025, “Head Mountable Display”) discloses a head-mountable display with a structural frame defining a viewing opening and an optical module coupled to the structural frame.

U.S. patent application publication 20250053011 (Schultz, Feb. 13, 2025, “Multi-Input Image Light Guide System”) discloses an image light guide system for conveying a virtual image via a first waveguide and a second waveguide. U.S. patent application publication 20250076671 (VanWyk et al., Mar. 6, 2025, “Artificial Reality Devices with Light Blocking Capability and Projection of Visual Content Over Regions of Blocked Light”) discloses a head-mounted device with a with liquid crystal display that emits polarized light and a polarizing filter. U.S. patent application publication 20250072764 (Panchawagh et al., Mar. 6, 2025, “Photoacoustic Sensor with Light-Steering System”) discloses a light-steering system to direct light emitted by at least a first light source of a light source system to a first plurality of areas of a target object, wherein controlling the light-steering system involves controlling one or more adjustable micromirrors, one or more adjustable lenses, and one or more adjustable diffraction gratings.

U.S. patent application publication 20250076649 (Lao et al., Mar. 6, 2025, “Waveguide Display with Multiple Joined Fields of View in a Single Substrate”) discloses a waveguide display with a substrate, projectors for projecting display light for different fields of view, input gratings configured to couple the display light for different fields of view into the substrate, and a two-dimensional grating. U.S. patent application publication 20250093567 (Born et al., Mar. 20, 2025, “Waveguide Display Having Gratings with Continuous Phase Shifting”) discloses a surface relief grating having a pitch that varies continuously along an axis orthogonal its ridges. U.S. patent application publication 20250110341 (Zimmerman et al., Apr. 3, 2025, “Head Mountable Display˜discloses a head-mountable display device with a structural frame and mounting bracket coupled to a side of the structural frame.

U.S. patent application publication 20250123592 (Gao et al., Apr. 17, 2025, “Optically Addressable Pixelated Spatial Light Modulator and Spatial Light Field Modulation Method”) discloses an optically addressable pixelated spatial light modulator comprising: a laser light source, a structured light field encoding projection module, and a superpixel metasurface device. U.S. patent application publication 20250181030 (Fieldhouse et al., Jun. 5, 2025, “Holographic Display System and Method for Expanding a Display Region”) discloses a spatial filter for positioning in a Fourier plane of a holographic display system. U.S. patent application publication 20250199307 (Lu et al., Jun. 19, 2025, “Transparent Display”) discloses a transparent display with a holographic diffuser extending in a two-dimensional diffuser plane.

U.S. patent application publication 20250216797 (Bissie et al., Jul. 3, 2025, “Optical Element for a Projection Exposure System, Optical System Comprising Same and Projection Exposure System Comprising the Optical Element and/or the Optical System”) discloses an optical element with a mirror section having an optically active surface. U.S. patent application publication 20250237939 (Yamagishi et al., Jul. 24, 2025, “Light Quantity Adjustment Device and Projection Image Display Device”) discloses a light quantity adjustment device including blade substrates that are each provided rotatably with a rotation axis and an actuation axis. U.S. patent application publication 20250251616 (Fattal et al., Aug. 7, 2025, “Static Multiview Display and Method Using Micro-Slit Scattering Elements”) discloses a static multiview display and method of static multiview display operation include micro-slit scattering elements.

U.S. patent application publication 20250272924 (Rockwell et al., Aug. 28, 2025, “Head Mountable Display”) discloses a head-mountable display device with a front opening and a rear opening, a display screen disposed in the front opening, a display assembly disposed in the rear opening, and a first securement strap coupled to the housing. U.S. patent application publication 20250273182 (Balsam et al., Aug. 28, 2025, “Head-Worn Displays with Multi-State Panels”) discloses the use of pixelated multi-state panels (e.g., liquid crystal dimming panels) in artificial reality (XR) displays.

### SUMMARY OF THE INVENTION

This invention is an optical structure for augmented reality eyewear which can transition between a real world viewing mode, a virtual reality viewing mode, and an augmented reality viewing mode. This eyewear shows bright opaque virtual objects in a portion of a person's field of view while providing the person with a clear view of the real world in the rest of their field of view. This eyewear includes an eyewear frame (e.g. an eyeglasses frame) which is worn by the person, an optical display on the frame which displays virtual objects, a transparent optical component (e.g. lens) in front of the person's eye, a micromirror array with a plurality of selectively-movable (e.g. pivoting or rotating) micromirrors, and an electroconductive pathway array.

The eyewear has a first configuration in which a selected subset of micromirrors allows light from the environment to pass through a selected portion of the transparent optical component to the person's eye and a second configuration in which the selected subset of micromirrors blocks at least some of the light from the environment from passing through the selected portion of the transparent optical component to the person's eye and reflects light from the optical display toward the person's eye in the selected portion of the transparent optical component. The eyewear is changed from its first configuration to its second configuration by the transmission of electrical energy through a selected subset of electroconductive pathways.

### BRIEF INTRODUCTION TO THE FIGURES

FIGS. 1 and 2 show frontal and top-down views, respectively, of augmented reality eyewear in a virtual reality viewing mode.

FIGS. 3 and 4 show frontal and top-down views, respectively, of this augmented reality eyewear in a real world viewing mode.

FIGS. 5 and 6 show frontal and top-down views, respectively, of this augmented reality eyewear in an augmented reality viewing mode.

FIG. 7 shows a frontal view of how a micromirror array can comprise an off-center section of an array of nested micromirror rings.

FIG. 8 shows a frontal view of how a micromirror array can comprise a central section of an array of nested micromirror rings.

FIG. 9 shows a close-up frontal view of how a micromirror can pivot or rotate around one of its edges.

FIG. 10 shows a close-up frontal view of how a micromirror can pivot or rotate around an interior (e.g. central) axis.

FIG. 11 shows a close-up cross-sectional view of how a micromirror can be pivoted or rotated around a central axis by transmission of electrical energy through a distal layer of electroconductive pathways.

FIG. 12 shows a closeup cross-sectional view of how a micromirror can be pivoted or rotated around an end axis by transmission of electrical energy through a distal layer of electroconductive pathways.

FIG. 13 shows a close-up cross-sectional view of how a micromirror can be pivoted or rotated around an end axis by transmission of electrical energy through (or between) proximal and distal layers of electroconductive pathways.

FIGS. 14 and 15 show close-up cross-sectional views of the angles of micromirrors in an array in a virtual reality viewing mode and in a real world viewing mode, respectively.

FIGS. 16 and 17 show close-up cross-sectional views of a stacked, multilayer, and/or 3D micromirror array between two layers of electroconductive pathways in a virtual reality viewing mode and in a real world viewing mode, respectively.

### DETAILED DESCRIPTION OF THE FIGURES

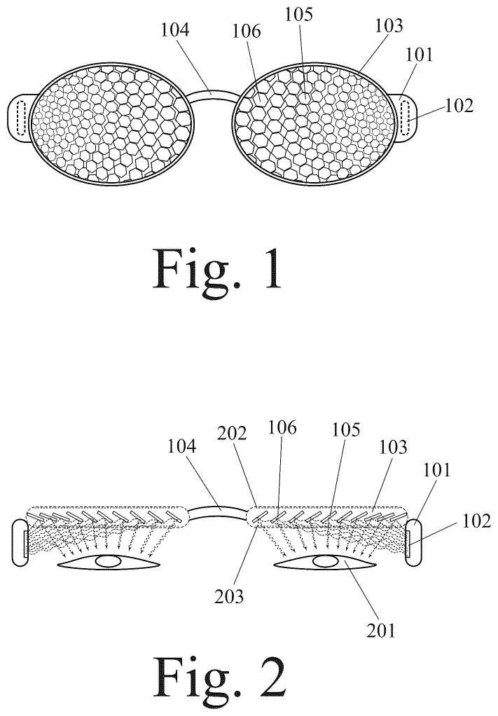

Before discussing the specific embodiments of this invention which are shown in FIGS. 1 through 17, this disclosure provides an introductory section which covers some of the general concepts, components, and methods which comprise this invention. Where relevant, these concepts, components, and methods can be applied as variations to the examples shown in FIGS. 1 through 17 which are discussed afterwards.

In an example, augmented reality eyewear can comprise: an eyewear frame which is configured to be worn on a person's head; an optical display comprising one or more light emitters which display an image; a transparent optical component which is held in front of the person's eye by the eyewear frame; a micromirror array in front of the person's eye, wherein the micromirror array comprises a plurality of selectively-movable micromirrors; and an electroconductive pathway array, wherein the electroconductive pathway array comprises a plurality of selectively-activated electroconductive pathways, and wherein activation comprises transmitting electrical energy through an electroconductive pathway; wherein the eyewear has a first configuration in which a selected subset of micromirrors in the micromirror array have a first configuration which allows light from the environment to pass through a selected portion of the transparent optical component to the person's eye; wherein the eyewear has a second configuration in which the selected subset of micromirrors in the micromirror array have a second configuration which blocks at least some of the light from the environment from passing through the selected portion of the transparent optical component to the person's eye and reflects light from the optical display toward the person's eye in the selected portion of the transparent optical component; and wherein the eyewear is changed from the first configuration to the second configuration by activation of a selected subset of electroconductive pathways.

In an example, the optical display can be to the right or left of the transparent optical component. In an example, there can be vertical rows of micromirrors in the micromirror array. In an example, the optical display can be above or below the transparent optical component. In an example, there can be horizontal rows of micromirrors in the micromirror array. In an example, there can be nested rings of micromirrors in the micromirror array. In an example, there can be two or more optical displays for each eye.

In an example, a micromirror can reflect light from a first optical display toward a person's eye at a first time and reflect light from a second optical display toward the person's eye at a second time. In an example, the electroconductive pathway array can further comprise a first layer of electroconductive pathways which is proximal to the micromirror array and a second layer of electroconductive pathways which is distal to the micromirror array. In an example, transmission of electrical energy through the electroconductive pathway array can create an electromagnetic field. In an example, micromirrors can be pivoted, rotated, or oscillated by changes in the electromagnetic field.

In an example, micromirrors can be pivoted, rotated, or oscillated by electromagnetic actuators. In an example, micromirrors can be pivoted, rotated, or oscillated by microfluidic flows. In an example, micromirrors can be pivoted, rotated, or oscillated by sonic waves. In an example, micromirrors in the first configuration can be parallel to lines of sight which extend out from the person's eye. In an example, angles between micromirrors in the second configuration and a central plane of the micromirror array can vary with increasing distance from the optical display.

In an example, micromirrors which are closer to the center of the micromirror array can be smaller than micromirrors which are farther from center of the micromirror array. In an example, micromirrors which are closer to the center of the array can be pivoted, rotated, or oscillated faster than micromirrors which are farther from the center of the array. In an example, micromirrors which are closer to the optical display can be smaller than micromirrors which are farther from the optical display. In an example, the eyewear can further comprises one or more other components selected from the group consisting of: camera, data processor, data receiver, data transceiver, data transmitter, electromagnetic actuators, inertial motion sensor, power source, speaker, and touch pad.

In an example, augmented reality eyewear can comprise: an eyewear frame which is configured to be worn on a person's head, wherein the eyewear frame further comprises a frontpiece and a sidepiece (e.g. also called a temple); an optical display on the sidepiece, wherein the optical display comprises one or more light emitters which display an image; a transparent optical component (e.g. lens) which is held in front of the person's eye by the eyewear frame; a micromirror array in front of the person's eye, wherein the micromirror array comprises a plurality of selectively-movable micromirrors; an electroconductive pathway array, wherein the electroconductive pathway array comprises a plurality of selectively-activated electroconductive pathways, wherein activation comprises transmitting electrical energy through an electroconductive pathway; and wherein the eyewear has a first configuration in which a selected subset of micromirrors in the micromirror array have a first configuration which allows light from the environment to pass through a selected portion of the transparent optical component to the person's eye; wherein the eyewear has a second configuration in which the selected subset of micromirrors in the micromirror array have a second configuration which blocks at least some of the light from the environment from passing through the selected portion of the transparent optical component to the person's eye and reflects light from the optical display toward the person's eye in the selected portion of the transparent optical component; and wherein the eyewear is changed from the first configuration to the second configuration by activation of a selected subset of electroconductive pathways.

In an example, augmented reality eyewear can comprise: an eyewear frame which is configured to be worn on a person's head; an optical display comprising one or more light emitters which display an image; a transparent optical component which is held in front of the person's eye by the eyewear frame; a micromirror array in front of the person's eye, wherein the micromirror array comprises a plurality of selectively-movable micromirrors; and an electroconductive pathway array, wherein the electroconductive pathway array comprises a plurality of selectively-activated electroconductive pathways, and wherein activation comprises transmitting electrical energy through an electroconductive pathway; wherein the eyewear has a first configuration in which a selected subset of micromirrors in the micromirror array have a first configuration which allows light from the environment to pass through a selected portion of the transparent optical component to the person's eye; wherein the eyewear has a second configuration in which the selected subset of micromirrors in the micromirror array have a second configuration which blocks at least a selected percentage of the light from the environment from passing through the selected portion of the transparent optical component to the person's eye and reflects light from the optical display toward the person's eye in the selected portion of the transparent optical component; and wherein the eyewear is changed from the first configuration to the second configuration by activation of a selected subset of electroconductive pathways.

In an example, there can be two augmented reality optical structures in the eyewear, one in front of each eye. In another example, a lens and micromirror array can be separate components. In an example, the optical display can be on the frontpiece of the eyewear frame (e.g. above the lens). In an example, micromirrors in a micromirror array can be moved (e.g. pivoted, oscillated, and/or rotated).

In an example, a line-of-sight can comprise a vector between (the center of) a micromirror and the center of the center of a person's eye. In another example, in a second configuration, a micromirror can be aligned with a line of sight from a person's eye and allow light from the environment to reach the person's eye. In an example, in one configuration, central planes of micromirrors in a movable micromirror array can intersect lines of sight extending radially out from (the retina of) a person's eye. In another example, micromirrors in an micromirror array can be parallel to radial vectors extending out from a person's retina (in a first or second configuration). In an example, micromirrors in an micromirror array can be perpendicular to radial vectors extending out from a person's retina (in a first or second configuration)

In an embodiment, a central plane of a micromirror array can be defined as the plane which best fits (e.g. minimizes the sum of squared deviations from) the centroids of micromirrors in the array. In an example, a micromirror array can have flat planar shape. In an example, micromirrors in an micromirror array can be coplanar in a second configuration. In an example, the rotational axles of micromirrors in an micromirror array can be coplanar.

In an example, a micromirror array can be located on the left half of a transparent optical component. In an example, a micromirror array can be located on the right half of a transparent optical component. In another example, a micromirror array can be moved from a first area of a person's field of view to a second area of the person's field of view. In an example, a micromirror array can be moved from a peripheral portion of a transparent optical component (e.g. lens) to a central portion of the transparent optical component. In another example, the location of a micromirror array in a person's field of view can be automatically adjusted. In an example, a micromirror array can span at least 80% of the area of a transparent optical component.

In an embodiment, a subset of micromirrors in a micromirror array can be rotated, oscillated, and/or pivoted (in the same clockwise or counter-clockwise direction). In an example, different individual micromirrors in the array can be selectively and independently moved by transmission of electrical energy through different electroconductive pathways. In an example, one or more micromirrors in a micromirror array can be selectively, individually, and/or independently moved (e.g. pivoted, oscillated, and/or rotated) by transmission of electrical energy through a selected subset of electroconductive pathways.

In an example, selection of different transparent electrical pathways for transmission of electrical energy can change the orientations and/or angles of micromirrors near those pathways. In an example, transmission of electrical energy through different transparent electrical pathways can cause micromirrors to move into different orientations and/or angles. In another example, when eyewear is in an augmented reality viewing mode, a selected subset of micromirrors in a micromirror array can block environmental light and reflect light from an optical display toward a person's eye, while the rest of the micromirrors allow a clear view of the real world.

In an example, a micromirror array can have a convex shape. In another example, a micromirror can have an asymmetric polygonal shape. In an example, micromirrors in a micromirror array can have hexagonal shapes. In an example, micromirrors in a micromirror array can interdigitate and/or interlock with each other. In an embodiment, there can be a many-to-one relationship between micromirrors and pixels. In an example, a micromirror array can comprise a plurality of micro blinds or louvers. In an example, micromirrors in a micromirror array can be arranged in horizontal rows. In another example, micromirrors in a micromirror array can be arranged in rows, wherein the distance between rows increases with distance from the center of the array.

In an example, a micromirror array can be configured like a selected section of a larger array such as an array of micromirrors aligned along nested (e.g. concentric) rings. In another example, an optical structure for augmented reality eyewear can include a micromirror array with a central zone of micromirrors and annular rings of micromirrors around the central zone, wherein micromirrors in the central zone are smaller than micromirrors in the annular rings. In an example, micromirrors in a micromirror array can be arranged in nested concave arcs.

In an example, micromirrors in a micromirror array can be radially symmetric. In an example, micromirrors on opposite sides (e.g. right and left) of an optical structure (e.g. lens) in front of a person's eye can be tilted and/or angled in opposite directions. In an example, micromirrors on opposite sides of the center of a person's field of view can be tilted and/or angled in opposite directions. In another example, micromirrors on opposite sides of the center of an optical structure (e.g. lens) in front of a person's eye can be tilted and/or angled in opposite directions.

In an example, the absolute value of changes in angles between micromirrors and a central plane of the micromirror array from virtual reality viewing mode to real world viewing mode can increase with increasing distance from an optical display. In another example, the first configuration micromirror angles of micromirrors in an array which are farther from an optical display can be greater than the first configuration micromirror angles of micromirrors in the array which are closer to the display. In an embodiment, there can be a linear relationship between the first configuration micromirror angles of micromirrors in an array and the distance of those micromirrors from an optical display.

In an example, there can be a monotonic relationship between the first configuration micromirror angles of micromirrors in an array and the distance of those micromirrors from an optical display. In an example, there can be a non-linear relationship between the first configuration micromirror angles of micromirrors in an array and the distance of those micromirrors from an optical display. In an example, there can be a quadratic relationship between the first configuration micromirror angles of micromirrors in an array and the distance of those micromirrors from an optical display.

In an example, the sizes of micromirrors in a micromirror array can increase with distance from the center of the array. In an example, there can be a monotonic relationship between the first configuration micromirror angles of micromirrors in an array and the distance of those micromirrors from the center of the array. In an example, there can be a non-linear relationship between the size of micromirrors in an array and the distance of those micromirrors from the center of the array. In another example, micromirrors can be rotationally-connected to axles within a micromirror array. In an example, micromirrors in an array can be movably suspended within a vacuum. In another example, micromirrors in an array can be movably suspended within a fluid. In an example, micromirrors in an array can be tortional micromirrors.

In an example, a micromirror can be transflective, reflecting between 20% and 50% of incident light. In an embodiment, a micromirror can be transflective, transmitting between 20% and 50% of incident light and reflecting the rest of incident light. In an example, a micromirror can be transflective, transmitting less than 30% of incident light and reflecting the rest of incident light. In another example, a micromirror array can be made with electrochromic material whose reflectivity is changed by the application of electrical energy through nearby electromagnetic pathways. In an example, an optical component for augmented reality eyewear can include a liquid crystal layer. In another example, a micromirror array can comprise an array of reflective prisms. In an example, augmented reality eyewear can include an array of tunable prisms.

In an example, both sides of a micromirror can be reflective. In an example, micromirrors in a movable micromirror array can be connected to each other by flexible and/or elastic reflective membranes. In an example, micromirrors in an array can be movably suspended by a plurality of microscale springs. In an example, in movable micromirror array can comprise a Fresnel lens in one of a plurality of array configurations. In another example, in movable micromirror array can comprise a section of a Fresnel lens in one of a plurality of array configurations. In an example, a micromirror array can comprise a stack of two or more micromirror layers. In another example, a micromirror array can comprise two or more parallel layers of micromirrors. In an example, micromirrors in different layers of an array can be staggered, wherein the centroids of multiple micromirrors are not colinear.

In an embodiment, a micromirror can be oscillated around an axis through the center the micromirror. In an example, a micromirror can be pivoted around an axis along a side of the micromirror. In an example, a micromirror can be rotated around an axis along a side of the micromirror. In an example, a micromirror can be rotated around the center the micromirror. In an example, a first set of micromirrors in a micromirror array can be rotated, oscillated, and/or pivoted in a first direction (e.g. clockwise or counter-clockwise) and a second set of micromirrors in the array can be rotated, oscillated, and/or pivoted in a second direction. In an example, a first subset of micromirrors in a micromirror array which is closer to an optical display can be rotated, oscillated, and/or pivoted at a first speed and a second subset of micromirrors which is farther from the optical display can be rotated, oscillated, and/or pivoted at a second speed. In an example, micromirrors in an array can have a rotational speed between 10 and 50 milliseconds per rotation. In another example, micromirrors in an array can pivot back and forth at least 100 times per second.

In an example, a micromirror can be moved (e.g. pivoted or rotated) by a change in an electric potential. In another example, a plurality of electroconductive pathways can include one or more magnetic coils which create one or more electromagnetic fields. In an example, an array of electroconductive pathways can comprise a first set of pathways in a first plane and a second set of pathways in a second plane, wherein (changes in) an electromagnetic field between the first and second planes moves mirrors in the micromirror array. In another example, augmented reality eyewear can comprise a layer of magnetic coils which create magnetic fields which move micromirrors in an array. In an example, micromirrors in an array can be movably suspended within an electromagnetic field. In an example, one or more vertexes of a micromirror can move in response to changes in an electromagnetic field. In an embodiment, transmission of electrical energy through electroconductive pathways can create an electromagnetic field which moves micromirrors.

In an example, a micromirror can comprise one or more ferromagnetic components which cause the micromirror to move in response to changes in an electromagnetic field. In an example, a micromirror can have metallic components which are moved by changes in an electromagnetic field. In an example, a micromirror can have one or more magnetically-responsive components which move in response to a change in an electromagnetic field. In another example, a micromirror can have one or more metallic components in one or more layers of the mirror which are moved by changes in an electromagnetic field.

In an example, a micromirror can have one or more metallic components located at one or more vertexes of the mirror which are moved by changes in voltage in one or more electrodes. In another example, a side of a micromirror can have a magnetic component which moves in response to a change in an electromagnetic field. In an example, a vertex of a micromirror can have a magnetically-responsive component which moves in response to a change in an electromagnetic field. In another example, one or more components of a micromirror can be ferromagnetic, paramagnetic, or diamagnetic. In an example, one or more vertexes of a micromirror can be ferromagnetic, paramagnetic, or diamagnetic.

In an example, a micromirror can be moved by one or more solenoids. In an example, a micromirror can be pivoted, tilted, and/or rotated by one or more (microscale) electromagnetic actuators which exert force on one or more vertexes of the micromirror. In an example, a micromirror can pivoted and/or tilted around a vertex by one or more solenoids. In an embodiment, micromirrors in a micromirror array can be selectively moved (e.g. pivoted or rotated) by a plurality of piezoelectric actuators.

In an example, a selected subset of micromirrors in a micromirror array can be moved by an acoustic pulse. In an example, augmented reality eyewear can include one or more acoustic energy generators which generate directed and/or targeted acoustic waves which move (a selected subset of) micromirrors in a micromirror array. In another example, micromirrors in an array can be moved (e.g. pivoted or rotated) by an acoustic wave. In an example, micromirrors in an array can be moved (e.g. pivoted or rotated) by microfluidic circuits. In another example, micromirrors in an array can be suspended in a fluid and moved (e.g. pivoted or rotated) by microfluidic flows.

In an example, an optical display can comprise a plurality of coherent light emitters. In an example, augmented reality eyewear can further comprise a light emitting diode pixel array display. In an example, augmented reality eyewear can include a (virtual image) display comprising a plurality of microLEDs. In an example, the optical structure of augmented reality eyewear can comprise a transparent OLED (AMOLED) layer. In an example, an optical display can be located on the front piece of eyewear, above a lens which is in front of a person's eye. In an example, an optical display can be slid manually along the longitudinal axis of a sidepiece (e.g. temple) of eyewear. In another example, the location of an optical display on a sidepiece (e.g. temple) of eyewear can be adjusted. In an embodiment, an optical display can comprise a circular array of light emitters.

In an example, augmented reality eyewear can further comprise one or more light guides (e.g. moving micromirrors) which redirect (e.g. reflect) light from an optical display to scan across the micromirror array in front of a person's eye. In an example, a pivoting or rotating micromirror can reflect light from a first optical display toward a person's eye at a first time and can reflect light from a second optical display toward the person's eye at a second time.

In an example, an array of electroconductive pathways can comprise a single layer of pathways which is proximal to (closer to the eye than) a micromirror array, wherein transmission of electrical energy through the pathways moves mirrors in the micromirror array. In an example, micromirrors in an array can be moved (e.g. pivoted or rotated) by the application of voltage and/or electrical current to a proximal array of electroconductive pathways. In an example, there may be only one layer of electroconductive pathways. In an example, micromirrors in an array can be moved (e.g. pivoted or rotated) by changes in voltage in one or more electrodes. In an example, there can be 3-4 electrodes for each micromirror in a micromirror array. In another example, transmission of electrical energy through different pairs of (transparent) electrodes can cause micromirrors to move into different orientations and/or angles.

In an example, an array of electroconductive pathways can comprise a grid or mesh of transparent (or translucent) electroconductive pathways with triangular gaps between pathways. In another example, an array of electroconductive pathways can comprise a hub-and-spoke array of electroconductive pathways. In an example, an array of electroconductive pathways can comprise an orthogonal grid or mesh of transparent (or translucent) electroconductive pathways with quadrilateral gaps between pathways. In another example, pathways in center of an array of electroconductive pathways can be closer together (e.g. more dense) than pathways in the periphery of the array.

In an example, augmented reality eyewear can include two layers of electroconductive pathways: a first layer which is proximal to a micromirror array; and a second layer which is distal to the micromirror array. In an embodiment, an array of electroconductive pathways can be made with a conductive polymer. In an example, an array of electroconductive pathways can be made with Indium Tin Oxide (ITO). In an example, electroconductive pathways can comprise carbon nanotubes.

In an example, augmented reality eyewear can further comprise an eye tracking component, wherein the tracking orientation of a person's eye helps to inform the angles to which micromirrors in an array are set for displaying virtual objects in the person's field of view and/or allowing light from the environment to reach the person's eye. In an example, augmented reality eyewear can further comprise an eye-tracking module which tracks the location and/or orientation of a person's eye, wherein the speed of changes in the orientations and/or angles of micromirrors is at least partly based on the location and/or orientation of the person's eye.

In an example, augmented reality eyewear can include a meta resonator with a negative refractive index. In another example, augmented reality eyewear can include a subwavelength metamaterial structure. In an example, micromirrors in an array can comprise planar structures with subwavelength nanostructures. In another example, micromirrors in an array can modulate the phase of incident light. In an example, augmented reality eyewear can further comprise an ambient light sensor. In another example, there may only be one augmented reality optical structure in front of just one eye. In an example, a micromirror array can be integrated with (e.g. inside) a lens. In an example, a micromirror array can comprise an array of reflective microstructures.

In an example, in a first configuration, a micromirror can block light from the environment from reaching a person's eye and can reflect light from an optical display to the person's eye. In an embodiment, a line-of-sight can comprise a vector between (the center of) a micromirror and the center of the pupil of a person's eye. In an example, in one configuration, central planes of micromirrors in a movable micromirror array can be orthogonal to lines of sight extending radially out from (the retina of) a person's eye. In an example, micromirrors in an micromirror array can be parallel (in a first configuration). In an example, micromirrors in an micromirror array can be parallel to radial vectors extending out from an optical display (in a first or second configuration). In an example, micromirrors in an micromirror array can be perpendicular to radial vectors extending out from an optical display (in a first or second configuration)

In an example, a micromirror array can have a planoconcave shape. In an example, a micromirror array plane can be defined as the plane which best fits (e.g. minimizing the sum of squared deviations from) the centroids of micromirrors in the array, a first configuration micromirror angle can be defined as the (display-facing) angle at which the central plane of the micromirror (or an extension thereof in 3D space) intersects the micromirror array plane when the mirror is in the first configuration, a second configuration micromirror angle can be defined as the (display-facing) angle at which the central plane of the micromirror (or an extension thereof in 3D space) intersects the micromirror array plane when the mirror is in the second configuration). In another example, micromirrors in an micromirror array can be coplanar.

In an example, a micromirror array can be automatically moved by an electromagnetic actuator from a first area of a person's field of view to a second area of the person's field of view in response to data from an environmental sensor. In another example, a micromirror array can be located on the lower left quadrant of a transparent optical component. In an example, a micromirror array can be located on the upper left quadrant of a transparent optical component. In an example, a micromirror array can be moved from a first portion of a transparent optical component (e.g. lens) to a second portion of the transparent optical component. In an embodiment, a micromirror array can be moved manually from a first area of a person's field of view to a second area of the person's field of view. In an example, the location of a micromirror array in a person's field of view can be manually adjusted by sliding a transparent arm to which the array is attached. In an example, a micromirror array can span between 50% and 75% of the area of a transparent optical component.

In an example, a subset of micromirrors in a micromirror array which correspond to the location of a virtual object being display in a person's field of view at a selected time can be moved (e.g. pivoted, oscillated, and/or rotated). In an example, different selected subsets of micromirrors in a micromirror array can be moved (e.g. pivoted, oscillated, and/or rotated) at different times, corresponding to different locations of displayed virtual objects in a person's field of view at different times. In another example, one or more micromirrors in a micromirror array can be selectively, individually, and/or independently moved (e.g. pivoted, oscillated, and/or rotated). In an example, the orientations and/or angles of micromirrors in an array can be selectively and individually controlled by transmitting electrical energy through a selected sub-set of electroconductive pathways. In another example, transmission of electrical energy through different transparent electrical pathways can cause one or more micromirrors between the pathways to move into different orientations and/or angles.

In an example, a micromirror array can comprise a honeycomb array of hexagonal-shaped micromirrors. In an example, a micromirror array can have a shape which is section of a cylinder. In an example, micromirrors in a micromirror array can have circular shapes. In an example, micromirrors in a micromirror array can have quadrilateral shapes. In an example, micromirrors in a micromirror array can overlap each other in a first or second configuration. In an example, there can be a one-to-many relationship between micromirrors and pixels.

In an embodiment, augmented reality eyewear can comprise an optical display above or

below a lens and a micromirror array in which micromirrors are arranged in horizontal rows. In an example, micromirrors in a micromirror array can be arranged in rows, wherein the areas between rows comprise less than 10% of the overall area of the array. In another example, micromirrors in a micromirror array can be arranged in rows, wherein there is a uniform distance between rows. In an example, an optical structure for augmented reality eyewear can include a dynamic micromirror array with a central zone of micromirrors and annular rings of micromirrors around the central zone, wherein micromirrors in the central zone move (e.g. pivot or rotate) more rapidly than micromirrors in the annular rings. In another example, an optical structure for augmented reality eyewear can include a micromirror array with a central zone of micromirrors and annular rings of micromirrors around the central zone. In an example, micromirrors in an array can be aligned along nested rings or arcs.

In an example, micromirrors on opposite sides (e.g. right and left) of an optical structure (e.g. lens) in front of a person's eye can be moved (e.g. pivoted or rotated) in opposite directions when they transition between a first (real world view) configuration to a second (virtual reality view) configuration. In an example, micromirrors on opposite sides of the center of a person's field of view can be moved (e.g. pivoted or rotated) in opposite directions when they transition between a first (real world view) configuration to a second (virtual reality view) configuration. In an example, micromirrors on opposite sides of the center of an optical structure (e.g. lens) in front of a person's eye can be moved (e.g. pivoted or rotated) in opposite directions when they transition between a first (real world view) configuration to a second (virtual reality view) configuration.

In an example, micromirrors in an array which are closer to an optical display can be smaller than micromirrors which are farther from the display. In another example, the absolute value of the difference between first configuration and second configuration micromirror angles can be greater for micromirrors which are farther from an optical display than for micromirrors which are closer to the display. In an example, the sizes of micromirrors in a micromirror array can increase with distance from an optical display. In another example, there can be a linear relationship between the size of micromirrors in an array and the distance of those micromirrors from an optical display. In an example, there can be a monotonic relationship between the size of micromirrors in an array and the distance of those micromirrors from an optical display. In another example, there can be a non-linear relationship between the size of micromirrors in an array and the distance of those micromirrors from an optical display. In an example, there can be a quadratic relationship between the size of micromirrors in an array and the distance of those micromirrors from an optical display.

In an example, there can be a linear relationship between the first configuration micromirror angles of micromirrors in an array and the distance of those micromirrors from the center of the array. In an embodiment, there can be a monotonic relationship between the size of micromirrors in an array and the distance of those micromirrors from the center of the array. In an example, there can be a quadratic relationship between the first configuration micromirror angles of micromirrors in an array and the distance of those micromirrors from the center of the array.

In an example, micromirrors in an array can be movably suspended between two laterally-shifting plates. In an example, a micromirror can be suspended in a fluid or gel. In an example, micromirrors in an array can be suspended in a liquid. In another example, movable microscale reflective components can comprise micromirrors in an array. In an example, a micromirror can be transflective, reflecting between 40% and 70% of incident light. In another example, a micromirror can be transflective, transmitting between 40% and 70% of incident light and reflecting the rest of incident light. In an example, a micromirror can be transflective. In an example, an optical structure for augmented realty eyewear can include a photochromic layer. In an example, an optical structure for augmented reality eyewear include a plurality of Chiral Nematic Liquid Crystals (CLCs). In an example, a micromirror can comprise a reflective prism.

In an example, both sides of a micromirror can be reflective, wherein different sides of the micromirror reflect light from different optical displays. In an example, one side of a micromirror can be reflective and the opposite side of the micromirror can be non-reflective. In another example, micromirrors in a movable micromirror array can be connected to each other by flexible, stretchable, and/or elastic material (e.g. membranes). In an embodiment, a micromirror array can be configured like a selected section of a Fresnel reflector. In an example, in movable micromirror array can comprise a Fresnel reflector in one of a plurality of array configurations. In an example, in movable micromirror array can comprise a section of a Fresnel reflector in one of a plurality of array configurations. In another example, a micromirror array can comprise a two or more layers of micromirrors, wherein micromirrors in different layers are laterally offset relative to each other. In an example, a micromirror in an array can comprise a first layer with a first refraction index and a second layer with a second refraction index.

In an example, a micromirror can be oscillated around an axis along a side of the micromirror. In an example, a micromirror can be oscillated back and forth around a central axis. In an example, a micromirror can be pivoted around an axis between two vertexes of the micromirror. In an example, a micromirror can be rotated around an axis between two vertexes of the micromirror. In an example, a micromirror can pivot around an axis between two of its vertexes. In an example, micromirrors in an micromirror array can all be rotated, oscillated, and/or pivoted in the same direction (e.g. clockwise or counter-clockwise). In an example, a first subset of micromirrors in a micromirror array which is closer to the center of the array can be rotated, oscillated, and/or pivoted at a first speed and a second subset of micromirrors which is farther from the center of the array can be rotated, oscillated, and/or pivoted at a second speed. In another example, micromirrors in an array can have a rotational speed between 25 and 100 milliseconds per rotation. In an embodiment, micromirrors in an array can pivot back and forth between 20 and 60 times per second.

In an example, a micromirror can be pivoted or rotated by changes in an electromagnetic field caused by (nearby) electroconductive pathways. In an example, a plurality of electroconductive pathways can include one or more magnetic coils. In an example, an array of electroconductive pathways can comprise a first set of pathways in a first plane and a second set of pathways in a second plane, wherein (changes in) transmission of electrical energy through pathways in the first and/or second planes moves mirrors in the micromirror array. In an example, micromirrors can be suspended within an electromagnetic field within a micromirror array. In an example, micromirrors in an array can be suspended in a fluid and moved (e.g. pivoted or rotated) by changes in an electromagnetic field.

In an example, the lateral location of a selected subset of electroconductive pathways which is activated in a distal layer of pathways can differ from the lateral location of a selected subset of electroconductive pathways which is activated in a proximal layer of payments. This difference can create electromagnetic field patterns which cause micromirrors in the array to have different orientations as a function of distance from an optical display and/or the center of the array. This difference can create electromagnetic field patterns which cause micromirrors in the array to have different changes in orientation from a first to a second configuration as a function of distance from an optical display and/or the center of the array.

In an example, a micromirror array can comprise an array of reflective magnetic microstructures. In an example, a micromirror can have a ferromagnetic, paramagnetic, or diamagnetic layer and/or coating. In another example, a micromirror can have metallic components which are moved by changes in voltage in one or more electrodes. In an example, a micromirror can have one or more metallic components along one or more portions of the perimeter of the mirror which are moved by changes in an electromagnetic field. In another example, a micromirror can have one or more metallic components in one or more layers of the mirror which are moved by changes in voltage in one or more electrodes.

In an embodiment, a micromirror can have one or more metallic components on one or more sides of the mirror which are moved by changes in an electromagnetic field. In another example, a side of a micromirror can have a magnetically-responsive component which moves in response to a change in an electromagnetic field. In an example, micromirrors in an array can have magnetic microstructures which cause the micromirrors to move in response to changes in an electromagnetic field. In an example, one or more components of a micromirror can be magnetic. In an example, one or more vertexes or sides of a micromirror can include ferromagnetic, paramagnetic, or diamagnetic material.

In an example, a micromirror can be pivoted, tilted, and/or rotated around a central axis by one or more (microscale) electromagnetic actuators. In an example, a micromirror can be pivoted, tilted, and/or rotated by one or more (microscale) electromagnetic actuators. In an example, a micromirror can pivoted and/or tilted around an edge by one or more solenoids. In another example, transmission of electrical energy through electroconductive pathways can power microscale actuators (e.g. MEMS devices) which move micromirrors.

In an example, a selected subset of micromirrors in a micromirror array can be oscillated back and forth by an acoustic wave. In another example, micromirrors in a micromirror array can be oscillated back and forth by an acoustic wave transmitted through the array. In an example, micromirrors in an array can be moved (e.g. pivoted or rotated) by sonic energy. In another example, micromirrors in an array can be moved (e.g. pivoted or rotated) by microfluidic flows. In an example, optical structures in augmented reality eyewear can each include two microfluidic layers with different refraction indexes.

In an example, an optical display can comprise a plurality of Light Emitting Diodes (LEDs). In an example, augmented reality eyewear can further comprise a liquid crystal on silicon display. In an embodiment, augmented reality eyewear can include thin film OLEDs. In an example, an optical display can be located on a sidepiece (e.g. temple) of eyewear, to one side (e.g. right or left) of a lens which is in front of a person's eye. In an example, an optical display can be located on the front piece of eyewear, above a person's eye. In another example, an optical display can slide along the longitudinal axis of a sidepiece (e.g. temple) of eyewear.

In an example, an optical display can be circular. In another example, an optical display can comprise a plurality of nested (e.g. concentric) rings, wherein each ring further comprises a plurality of light emitters. In an example, a pivoting or rotating micromirror can reflect light from a first optical display toward a person's eye at a first time and can reflect light from a second optical display toward the person's eye at a second time, wherein the first optical display is to the right of a lens (and/or the person's eye) and the second optical display is to the left of the lens (and/or the person's eye). In another example, a pivoting or rotating micromirror can reflect light from different optical displays at different times.

In an example, augmented reality eyewear can include a layer comprising a matrix of electroconductive pathways. In an example, micromirrors in an array can be moved (e.g. pivoted or rotated) by the application of voltage to electrodes in an electroconductive layer. In an example, an electroconductive pathway can be an electrode. In an example, selection of different pairs of (transparent) electrodes for transmission of electrical energy can change the orientations and/or angles of micromirrors between those electrodes. In an example, there can be a plurality of steering electrodes for each micromirror. In an example, transmission of electrical energy through different pairs of (transparent) electrodes can cause one or more micromirrors between the electrodes to move into different orientations and/or angles.

In an example, an array of electroconductive pathways can comprise a hexagonal (e.g. honeycomb) grid or mesh of transparent (or translucent) electroconductive pathways. In an example, an array of electroconductive pathways can comprise a plurality of nested (e.g. concentric) electroconductive rings. In another example, an array of electroconductive pathways can comprise an orthogonal grid or mesh of transparent (or translucent) electroconductive pathways. In an example, pathways in center of an array of electroconductive pathways can be thinner than pathways in the periphery of the array.

In an example, micromirrors in an array can be moved (e.g. pivoted or rotated) by the application of voltage and/or electrical current to proximal and distal electroconductive pathways. In an embodiment, an array of electroconductive pathways can be made with carbon nanotubes. In an example, an array of electroconductive pathways can be made with nanowires. In an example, one or more transparent electroconductive pathways can be made from carbon nanotubes, fluorine doped tin oxide, fluorine doped zinc oxide, graphene, indium tin oxide, and/or transparent aluminum.

In an example, augmented reality eyewear can further comprise an eye-tracking module which tracks the location and/or orientation of a person's eye, wherein the locations of micromirrors in an array whose orientations and/or angles are changed are at least partly based on the location and/or orientation of the person's eye. In an example, a micromirror array can comprise a plurality of silicon nanoresonators. In an example, augmented reality eyewear can include a resonator which resonates with electromagnetic waves or mechanical vibrations at specific frequencies. In an example, augmented reality eyewear can include one or more metamaterial components with negative refractive indexes. In an example, micromirrors in an array can have metasurfaces. In another example, micromirrors in an array can modulate the vectors of incident light. In an example, this eyewear can further comprise one or more other components selected from the group consisting of: a power source (e.g. battery); a (wireless) data receiver, data transmitter, or data transceiver; a camera; a data processor; a speaker; one or more electromagnetic actuators; a touch pad; and a motion sensor.

In an example, eyewear can be embodied in a pair of eyeglasses. In an example, a lens and micromirror array can be separate component which are parallel to each other. In this example, the optical display can be on the sidepiece (or temple) of the eyewear frame. In another example, a transparent optical component can be a lens. In an example, augmented reality eyewear can further comprise one or more light guides (e.g. moving micromirrors) which redirect (e.g. reflect) light from an optical display to the micromirror array in front of a person's eye. In an embodiment, when eyewear is in a virtual reality viewing mode, all of the micromirrors in a micromirror array can block light from the environment from reaching the person's eye and reflect light from the optical display toward the person's eye, resulting in the person seeing an entirely virtual world.

In an example, a line-of-sight can comprise a vector between (the center of) a micromirror and the center of the retina of a person's eye. In an example, in one configuration, central planes of micromirrors in a movable micromirror array can be parallel to lines of sight extending radially out from (the retina of) a person's eye. In an example, micromirrors in an micromirror array can be parallel to lines of sight from a person's eye (in a first or second configuration). In an example, micromirrors in an micromirror array can be perpendicular to lines of sight from a person's eye (in a first or second configuration). In another example, when eyewear is in a real world viewing mode, all of the micromirrors in a micromirror array can be parallel to lines of sight from the person's eye, thereby giving the person a clear view of the real world. In an example, a micromirror array can have a planoconvex shape. In another example, micromirrors in an micromirror array can be coplanar in a first configuration. In an example, the centroids of micromirrors in an micromirror array can be coplanar.

In an example, a micromirror array can be automatically moved by an electromagnetic actuator from a first area of a person's field of view to a second area of the person's field of view. In an example, a micromirror array can be located on the lower right quadrant of a transparent optical component. In an example, a micromirror array can be located on the upper right quadrant of a transparent optical component. In an example, a micromirror array can be moved from a peripheral portion of a person's field of view to a central portion of the person's field of view. In an embodiment, a micromirror array can span the entire area of a transparent optical component. In an example, the location of a micromirror array in a person's field of view can be manually adjusted. In an example, a micromirror array can span between 70% and 90% of the area of a transparent optical component.

In an example, a subset of micromirrors within the perimeter of a virtual object displayed in a person's field of view can be moved from a configuration wherein they are parallel to lines of sight from the person's eye to a configuration wherein they reflect light from the display showing the virtual object. In an example, individual micromirrors can be moved (e.g. pivoted or rotated) by transmission of electrical energy through nearby electroconductive pathways. In another example, selection of different transparent electrical pathways for transmission of electrical energy can change the orientations and/or angles of micromirrors between those pathways. In an example, the orientations and/or angles of micromirrors in an array can be selectively and individually controlled. In another example, transmission of electrical energy through different transparent electrical pathways can cause one or more nearby micromirrors to move into different orientations and/or angles.

In an example, a micromirror array can have a concave shape. In an example, a micromirror array can have an arcuate shape. In an example, micromirrors in a micromirror array can have convex shapes. In an example, micromirrors in a micromirror array can have trapezoidal and/or keystone shapes. In an embodiment, micromirrors in an array can vary in size. In an example, there can be a one-to-one correspondence between micromirrors and pixels.

In an example, augmented reality eyewear can comprise an optical display to one side (left or right) of a lens and a micromirror array in which micromirrors are arranged in vertical rows. In an example, micromirrors in a micromirror array can be arranged in rows, wherein the distance between rows increases with distance from an optical display. In another example, micromirrors in a micromirror array can be arranged in vertical rows. In an example, an optical structure for augmented reality eyewear can include a micromirror array with a central zone of micromirrors and annular rings of micromirrors around the central zone, wherein micromirrors in the central zone are closer together than micromirrors in the annular rings. In another example, micromirrors in a micromirror array can be arranged in nested (e.g. concentric) rings.

In an example, micromirrors in a micromirror array can be radially asymmetric. In an example, micromirrors on opposite sides (e.g. right and left) of an optical structure (e.g. lens) in front of a person's eye can be moved (e.g. pivoted or rotated) in opposite directions. In an example, micromirrors on opposite sides of the center of a person's field of view can be moved (e.g. pivoted or rotated) in opposite directions. In an example, micromirrors on opposite sides of the center of an optical structure (e.g. lens) in front of a person's eye can be moved (e.g. pivoted or rotated) in opposite directions.

In an embodiment, the (display-facing) angles between micromirrors and a central plane of the micromirror array in virtual reality viewing mode can increase with increasing distance from the optical display. In this example, this increase is monotonic. In an example, the angles between micromirrors and a central plane of the array can increase with increasing distance from an optical display in the first configuration and/or the second configuration. In an example, there can be a linear relationship between the absolute value of the difference between first and second configuration micromirror angles for micromirrors in an array and the distance of those micromirrors from an optical display.

In an example, there can be a monotonic relationship between the absolute value of the difference between first and second configuration micromirror angles for micromirrors in an array and the distance of those micromirrors from an optical display. In an example, there can be a non-linear relationship between the absolute value of the difference between first and second configuration micromirror angles for micromirrors in an array and the distance of those micromirrors from an optical display. In another example, there can be a quadratic relationship between the absolute value of the difference between first and second configuration micromirror angles for micromirrors in an array and the distance of those micromirrors from an optical display.

In an example, micromirrors in an array which are closer to the center of the array (and/or closer to the center of a person's field of vision from an eye) can be smaller than micromirrors which are farther from the center of the array. In an example, there can be a linear relationship between the size of micromirrors in an array and the distance of those micromirrors from the center of the array. In an example, there can be a non-linear relationship between the first configuration micromirror angles of micromirrors in an array and the distance of those micromirrors from the center of the array. In an example, there can be a quadratic relationship between the size of micromirrors in an array and the distance of those micromirrors from the center of the array.

In an embodiment, micromirrors in an array can be movably suspended within a gas. In an example, micromirrors can be suspended within a liquid or gel within a micromirror array. In an example, micromirrors in an array can be MEMS mirrors. In an example, a micromirror can be transflective (e.g. partly transmissive and partly reflective). In another example, a micromirror can be transflective, reflecting between 60% and 90% of incident light. In an example, a micromirror can be transflective, transmitting between 5% and 30% of incident light and reflecting the rest of incident light. In another example, a micromirror array can be made with electrochromic material whose reflectivity is changed by the application of electrical energy (e.g. through nearby electromagnetic pathways). In another example, a micromirror array can comprise a plurality of Chiral Nematic Liquid Crystals (CLCs).

In an example, a dynamic micromirror array can comprise an array of pivoting and/or rotating reflective prisms. In an example, augmented reality eyewear can include an array of movable reflective prisms. In an example, both sides of a micromirror can be reflective, wherein different sides of the micromirror reflect light from optical displays on different sides of a lens (e.g. to the right and left of the person's eye). In an example, micromirrors in a movable micromirror array can be connected to each other by flexible and/or elastic non-reflective membranes. In an embodiment, micromirrors in an array can be attached to an optical structure by a plurality of microscale springs. In an example, a micromirror array can comprise a Fresnel lens. In an example, in movable micromirror array can comprise a Quasi Fresnel Reflector (QFR) in one of a plurality of array configurations. In an example, a micromirror array can comprise a single layer of micromirrors. In an example, a micromirror array can comprise two or more layers of micromirrors. In another example, micromirrors in different layers of an array can be stacked, wherein the centroids of multiple micromirrors can be colinear.

In an example, a micromirror can be oscillated around an axis between two vertexes of the micromirror. In another example, a micromirror can be oscillated back and forth around an axis between two vertexes. In an example, a micromirror can be pivoted around an axis through the center the micromirror. In another example, a micromirror can be rotated around an axis through the center the micromirror. In an example, a micromirror can pivot around one of its edges.

In an example, a first subset of micromirrors in a micromirror array can be rotated, oscillated, and/or pivoted at a first speed and a second subset of micromirrors in the array can be rotated, oscillated, and/or pivoted at a second speed. In an example, a first subset of micromirrors in a micromirror array which is closer to the center of the array can be rotated, oscillated, and/or pivoted at a first speed and a second subset of micromirrors which is farther from the center of the array can be rotated, oscillated, and/or pivoted at a second speed, wherein the first speed is faster than the second speed. In an example, micromirrors in an array can have a rotational speed less than 20 milliseconds per rotation. In an embodiment, micromirrors in an array can pivot back and forth between 50 and 100 times per second.

In an example, a micromirror can be suspended in and/by a magnetic field. In another example, a selected subset of micromirrors in a micromirror array can be oscillated back and forth by an electromagnetic wave. In an example, an array of electroconductive pathways can comprise two layers of pathways, a first layer which is distal to (farther from the eye than) a micromirror array and a second layer which is proximal to (closer to the eye than) the micromirror array, wherein changes in an electromagnetic field between pathways in the first and second layers moves mirrors in the micromirror array. In another example, micromirrors in a micromirror array can be oscillated back and forth by a variable electromagnetic wave. In another example, one or more components of a micromirror can move in response to changes in an electromagnetic field. In an example, transmission of electrical energy through a electroconductive pathways can create an electromagnetic field which moves micromirrors.

In an example, a micromirror can comprise one or more components made from nickel, gadolinium, cobalt, and/or iron. In an example, a micromirror can have a magnetic layer and/or coating. In an example, a micromirror can have one or more magnetic components which move in response to a change in an electromagnetic field. In an example, a micromirror can have one or more metallic components along one or more portions of the perimeter of the mirror which are moved by changes in voltage in one or more electrodes. In an example, a micromirror can have one or more metallic components located at one or more vertexes of the mirror which are moved by changes in an electromagnetic field. In an embodiment, a micromirror can have one or more metallic components on one or more sides of the mirror which are moved by changes in voltage in one or more electrodes. In an example, a vertex of a micromirror can have a magnetic component which moves in response to a change in an electromagnetic field. In another example, micromirrors in an array can have microstructures made cobalt, gadolinium, iron, nickel, platinum, and/or alloys thereof. In an example, one or more layers of a micromirror can include ferromagnetic, paramagnetic, or diamagnetic material.

In an example, a micromirror can be moved by a plurality of actuators which push or pull edges or vertexes of the micromirror. In an example, a micromirror can be pivoted, tilted, and/or rotated around a central axle by one or more (microscale) electromagnetic actuators which rotate the axle. In another example, a micromirror can pivoted and/or tilted around a central axis by one or more solenoids. In an example, a micromirror can pivoted and/or tilted by one or more solenoids. In an example a subset of micromirrors in an array can be selectively moved (e.g. pivoted or rotated) by a targeted acoustic wave. In an example, an optical structure in augmented reality eyewear can include a photoacoustic micromirror array, wherein selected subsets of micromirrors in the array can be moved by directed and/or targeted acoustic waves. In an example, micromirrors in an array can be moved (e.g. pivoted or rotated) by acoustic energy. In an example, augmented reality eyewear can comprise an array of microfluidic moving mirrors. In an example, micromirrors in an array can be moved (e.g. pivoted or rotated) by microfluidics.

In an embodiment, an optical display can comprise a MicroLED display. In another example, an optical display can comprise a plurality of micro-LEDs. In an example, augmented reality eyewear can further comprise a scanning mirror display. In another example, the display used in augmented reality eyewear can be selected from the group consisting of: active-matrix organic light emitting display (AMOLED), inorganic light emitting diode (ILED) display, liquid crystal display (LCD), organic light emitting diode (OLED) display, and transparent organic light emitting display (TOLED), micro light emitting diode (uLED) display, and crystalline semiconductor light emitting diode display

In an example, an optical display can be located on a sidepiece (e.g. temple) of eyewear. In another example, an optical display can be slid automatically (e.g. by an electromagnetic actuator) along the longitudinal axis of a sidepiece (e.g. temple) of eyewear. In an example, the distance by which an optical display extends out from the sidepiece (e.g. temple) of eyewear can be adjusted. In an example, an optical display can be rectangular. In an example, an optical display can comprise a rectangular array of light emitters. In an example, a pivoting or rotating micromirror can reflect light from a first optical display toward a person's eye at a first time and can reflect light from a second optical display toward the person's eye at a second time, wherein the first optical display is above a lens (and/or the person's eye) and the second optical display is below the lens (and/or the person's eye).

In an example, an array of electroconductive pathways can comprise a single layer of pathways which is distal to (farther from the eye than) a micromirror array, wherein transmission of electrical energy through the pathways moves mirrors in the micromirror array. In an example, micromirrors in an array can be moved (e.g. pivoted or rotated) by the application of voltage and/or electrical current to a distal array of electroconductive pathways. In an example, the orientation and/or angle of a micromirror can be changed by changing the voltage between first and second electroconductive pathways.

In an example, augmented reality eyewear can include two layers of electrodes: a first layer which is proximal to a micromirror array; and a second layer which is distal to the micromirror array. In an embodiment, selection of different pairs of (transparent) electrodes for transmission of electrical energy can change the orientations and/or angles of micromirrors near those electrodes. In another example, there can be two electrodes for each micromirror in a micromirror array. In another example, transmission of electrical energy through different pairs of (transparent) electrodes can cause one or more nearby micromirrors to move into different orientations and/or angles.

In an example, an array of electroconductive pathways can comprise a honeycomb grid or mesh of transparent (or translucent) electroconductive pathways with hexagonal gaps between pathways. In an example, an array of electroconductive pathways can comprise a radial and/or starburst array of electroconductive pathways. In another example, pathways in an array of electroconductive pathways which are closer to the optical display can be closer together (e.g. more dense) than pathways which are farther from the optical display.

In an example, an array of electroconductive pathways can comprise two layers of pathways, a first layer which is distal to (farther from the eye than) a micromirror array and a second layer which is proximal to (closer to the eye than) the micromirror array, wherein transmission of electrical energy through pathways in the first and/or second layers moves mirrors in the micromirror array. In an example, there can two layers or electroconductive pathways: a first set of electroconductive pathways which is distal to (e.g. farther from the eye than) the micromirror array; and a second set of electroconductive pathways is proximal to (e.g. closer to the eye than) the micromirror array. In an example, an array of electroconductive pathways can be made with graphene. In an example, an array of electroconductive pathways can be made with transparent conducting film.

In an example, augmented reality eyewear can also include an eye tracking mechanism. In an example, augmented reality eyewear can further comprise an eye-tracking module which tracks the location and/or orientation of a person's eye, wherein the orientations and/or angles of micromirrors in a micromirror array are at least partly based on the location and/or orientation of the person's eye. In an example, an optical structure for augmented reality eyewear can comprise an array of silicon nanoresonators. In an example, augmented reality eyewear can include a split-ring resonator. In an example, micromirrors in an array can be made with metamaterial. In an example, micromirrors in an array can modulate the amplitude of incident light. In an embodiment, augmented reality eyewear can further comprise a microphone.

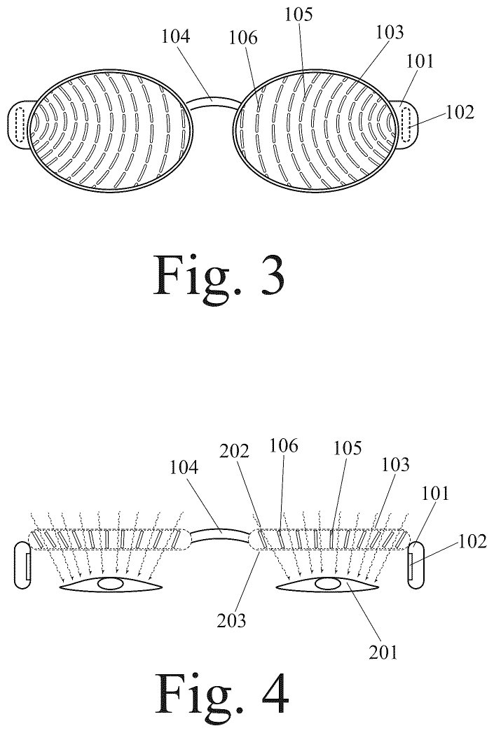

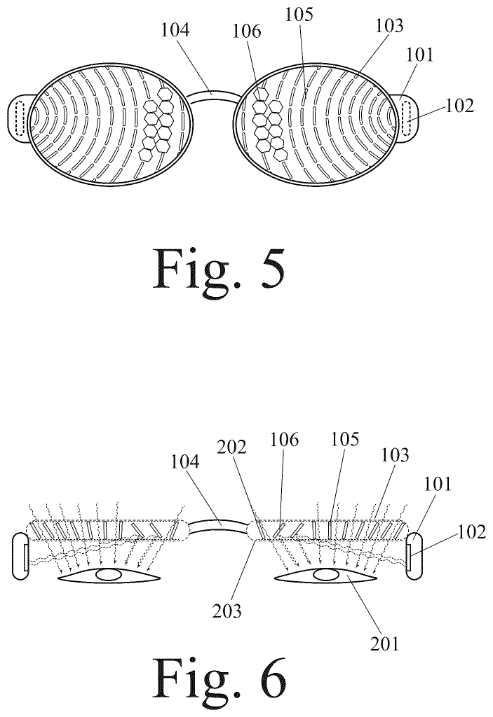

FIGS. 1 through 6 show an example of augmented reality eyewear that can transition between a virtual reality viewing mode (shown in FIGS. 1 and 2), a real world viewing mode (shown in FIGS. 3 and 4), and an augmented reality viewing mode (shown in FIGS. 5 and 6). FIGS. 1, 3, and 5 show frontal views of this eyewear. FIGS. 2, 4, and 6 show top-down cross-sectional views of this eyewear.

FIGS. 1 and 2 show the eyewear in virtual reality viewing mode in which all of the micromirrors intersect lines of sight from the person's eye. The micromirrors all block light from the environment from reaching the person's eye and all reflect light from the optical display toward the person's eye. As a result, the person's field of view is an entirely virtual world. FIGS. 3 and 4 show the eyewear in a real world viewing mode in which all of the micromirrors are parallel to lines of sight from the person's eye. The micromirrors all allow light from the environment to reach the person's eye and the optical display is not activated. As a result, the person has a clear view of the real world. No virtual objects are displayed in their field of view. FIGS. 5 and 6 show the eyewear in an augmented reality viewing mode in which a subset of the micromirrors intersect lines of sight from the person's eye. Micromirrors in this subset block light from the environment from reaching the person's eye and reflect light from the optical display toward the person's eye. The rest of the micromirrors are parallel to lines of sight. As a result, relatively-opaque virtual objects are shown in a portion of the person's field of view and the person has a clear view of the real world in the rest of their field of view.

With respect to components, FIGS. 1 through 6 show an example of augmented reality eyewear comprising: an eyewear frame which is configured to be worn on a person's head; an optical display comprising one or more light emitters which display an image; a transparent optical component which is held in front of the person's eye by the eyewear frame; a micromirror array in front of the person's eye, wherein the micromirror array comprises a plurality of selectively-movable micromirrors; an electroconductive pathway array, wherein the electroconductive pathway array comprises a plurality of selectively-activated electroconductive pathways, wherein activation comprises transmitting electrical energy through an electroconductive pathway; and wherein the eyewear has a first configuration in which a selected subset of micromirrors in the micromirror array have a first configuration which allows light from the environment to pass through a selected portion of the transparent optical component to the person's eye; wherein the eyewear has a second configuration in which the selected subset of micromirrors in the micromirror array have a second configuration which blocks at least some of the light from the environment from passing through the selected portion of the transparent optical component to the person's eye and reflects light from the optical display toward the person's eye in the selected portion of the transparent optical component; and wherein the eyewear is changed from the first configuration to the second configuration by activation of a selected subset of electroconductive pathways.

Relating this to labeled components in FIGS. 1 through 6, this augmented reality eyewear comprises: an eyewear frame which is configured to be worn on a person's head, wherein the eyewear frame further comprises a frontpiece 104 and a sidepiece (e.g. also called a “temple”) 101; an optical display 102 on the sidepiece, wherein the optical display comprises one or more light emitters which display an image; a transparent optical component (e.g. lens) 103 which is held in front of the person's eye 201 by the eyewear frame; a micromirror array in front of the person's eye, wherein the micromirror array comprises a plurality of selectively-movable micromirrors, including micromirrors 105 and 106; an electroconductive pathway array, wherein the electroconductive pathway array comprises a plurality of selectively-activated electroconductive pathways, including 202 and 203, wherein activation comprises transmitting electrical energy through an electroconductive pathway; and wherein the eyewear has a first configuration in which a selected subset of micromirrors (including 106) in the micromirror array have a first configuration (shown in FIG. 4) which allows light from the environment to pass through a selected portion of the transparent optical component to the person's eye; wherein the eyewear has a second configuration in which the selected subset of micromirrors (including 106) in the micromirror array have a second configuration (shown in FIG. 6) which blocks at least some of the light from the environment from passing through the selected portion of the transparent optical component to the person's eye and reflects light from the optical display toward the person's eye in the selected portion of the transparent optical component; and wherein the eyewear is changed from the first configuration to the second configuration by activation of a selected subset of electroconductive pathways.

In an example, this eyewear can be embodied in a pair of eyeglasses. In an example, there can be two augmented reality optical structures in the eyewear, one in front of each eye. In another example, there may only be one augmented reality optical structure in front of just one eye. In an example, the transparent optical component can be a lens. In an example, the micromirror array can be integrated with (e.g. inside) the lens. In another example, the lens and micromirror array can be separate components. In another example, the lens and micromirror array can be separate component which are parallel to each other. In this example, the optical display can be on the sidepiece (or “temple”) of the eyewear frame. In another example, the optical display can be on the frontpiece of the eyewear frame (e.g. above the lens).

In an example, the micromirror array can comprise a honeycomb array of hexagonal-shaped micromirrors. In an example, micromirrors in an array can be aligned along nested rings or arcs. In an example, micromirrors in an array can vary in size. In an example, micromirrors in an array which are closer to an optical display can be smaller than micromirrors which are farther from the display. In an example, micromirrors in an array which are closer to the center of the array (and/or closer to the center of a person's field of vision from an eye) can be smaller than micromirrors which are farther from the display.

In an example, micromirrors in the micromirror array can be moved (e.g. pivoted, oscillated, and/or rotated). In an example, one or more micromirrors in the micromirror array can be selectively, individually, and/or independently moved (e.g. pivoted, oscillated, and/or rotated). In an example, a subset of micromirrors in the micromirror array which correspond to the location of a virtual object being display in a person's field of view at a selected time can be moved (e.g. pivoted, oscillated, and/or rotated). In an example, different selected subsets of micromirrors in the micromirror array can be moved (e.g. pivoted, oscillated, and/or rotated) at different times, corresponding to different locations of displayed virtual objects in a person's field of view at different times. In an example, one or more micromirrors in the micromirror array can be selectively, individually, and/or independently moved (e.g. pivoted, oscillated, and/or rotated) by transmission of electrical energy through a selected subset of electroconductive pathways. In an example, transmission of electrical energy through a electroconductive pathways can create an electromagnetic field which moves micromirrors.

In an example, there can two layers or electroconductive pathways: a first set of electroconductive pathways which is distal to (e.g. farther from the eye than) the micromirror array; and a second set of electroconductive pathways is proximal to (e.g. closer to the eye than) the micromirror array. In another example, there can be only one layer of electroconductive pathways. In an example, this eyewear can further comprise one or more other components selected from the group consisting of: a power source (e.g. battery); a (wireless) data receiver, data transmitter, or data transceiver; a camera; a data processor; a speaker; one or more electromagnetic actuators; a touch pad; and a motion sensor. Relevant variations discussed elsewhere in this disclosure or in priority-linked disclosures can also be applied to this example.

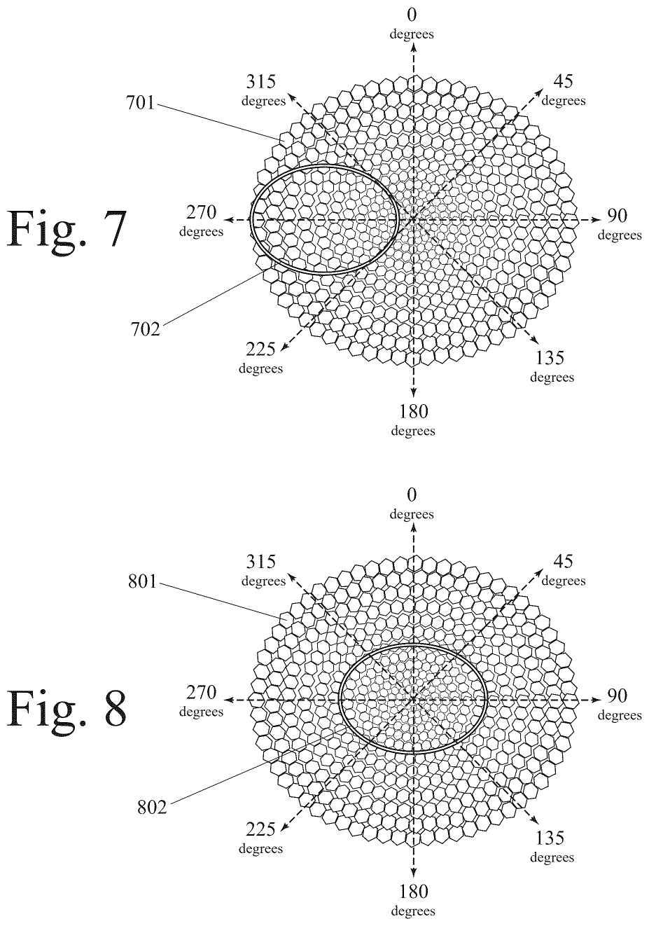

FIGS. 7 and 8 show examples of how a micromirror array can be configured like a selected section of a larger array such as an array of micromirrors aligned along nested (e.g. concentric) rings. In an example, the larger array can comprise a Fresnel reflector. FIG. 7 shows a selected micromirror array within oval 702 which is configured like a selected section of a larger array 701. In FIG. 7, the selected section is between the 225-degree and 315-degree radial spokes of the larger array. This selected section may be useful for a micromirror array in front of a person's eye when the optical display is located to the right or left of the person's eye. In an example, the location of the optical display can correspond to the center of the larger array. In another example, a selected section is between the 135-degree and 225-degree radial spokes of the larger array may be useful for a micromirror array in front of a person's eye when the optical display is located above the person's eye. In an example, the location of the optical display can correspond to the center of the larger array. FIG. 8 shows a selected micromirror array within oval 802 which is configured like a selected section of a larger array 801. In FIG. 8, the selected section is concentric with the larger array.

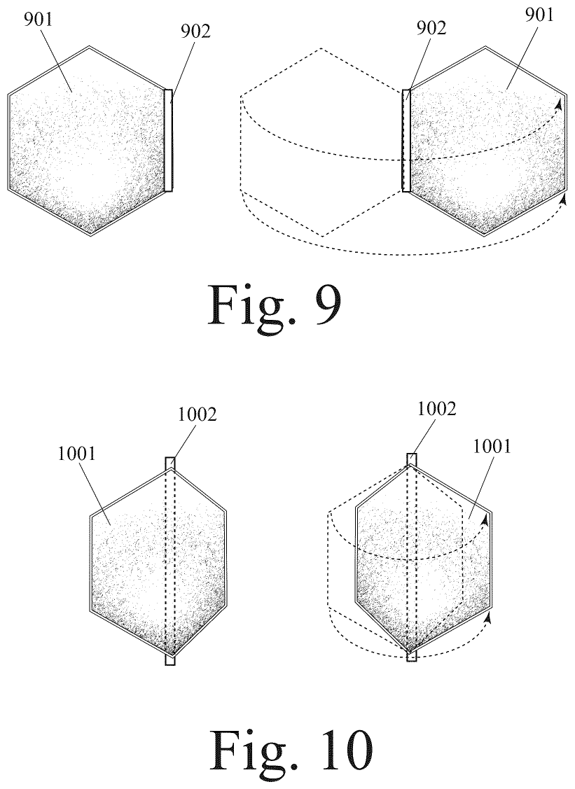

FIGS. 9 and 10 show close-up views of examples of how two different micromirrors can be move (e.g. pivot or rotate). FIG. 9 shows an example of a how a micromirror 901 can pivot around one of its edges 902. The left portion of FIG. 9 shows a this micromirror in a first configuration. The right portion of FIG. 9 shows this micromirror in a second configuration after the micromirror has pivoted around one of its edges. In this example, the micromirror has a hexagonal shape. FIG. 10 shows an example of a how a micromirror 1001 can pivot around an axis 1002 between two of its vertexes. The left portion of FIG. 10 shows a this micromirror in a first configuration. The right portion of FIG. 10 shows this micromirror in a second configuration after the micromirror has pivoted around one of its edges. In this example, the micromirror has an asymmetric polygonal shape to better show rotation; if it were symmetric and rotated around its central axis, then the left and right figures would look the same.

In an example, a micromirror can be pivoted or rotated by changes in an electromagnetic field caused by (nearby) electroconductive pathways. In an example, one or more vertexes or sides of a micromirror can include ferromagnetic, paramagnetic, or diamagnetic material. In an example, one or more layers of a micromirror can include ferromagnetic, paramagnetic, or diamagnetic material. In an example, in a first configuration, a micromirror can block light from the environment from reaching a person's eye and can reflect light from an optical display to the person's eye. In an example, in a second configuration, a micromirror can be aligned with a line of sight from a person's eye and allow light from the environment to reach the person's eye.

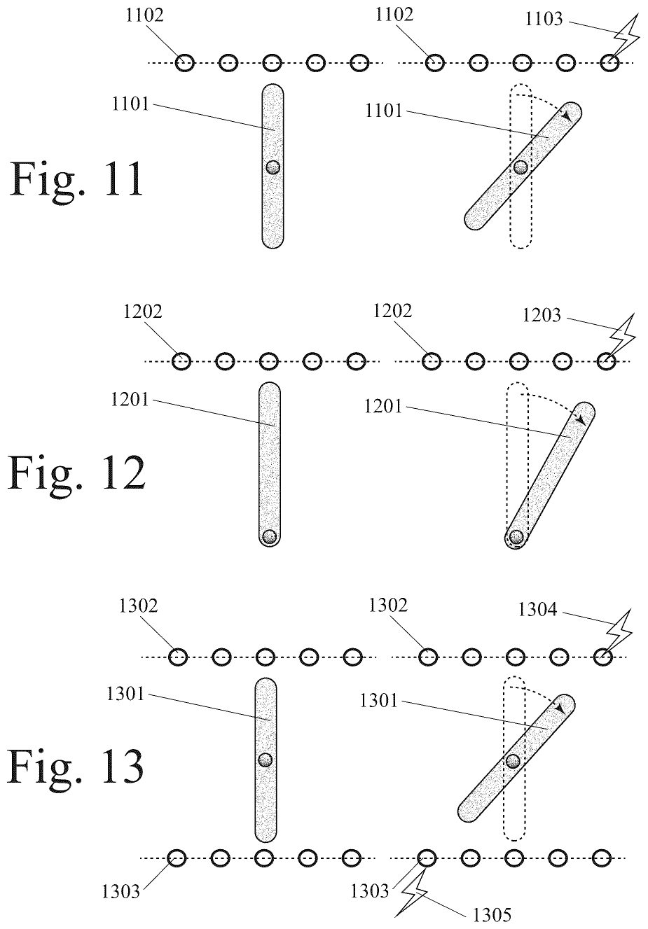

FIGS. 11 through 13 show close-up views of examples of how individual micromirrors can be moved (e.g. pivoted or rotated) by transmission of electrical energy through nearby electroconductive pathways. In an example, transmission of electrical energy through electroconductive pathways can create an electromagnetic field which moves micromirrors. In another example, transmission of electrical energy through electroconductive pathways can power microscale actuators (e.g. MEMS devices) which move micromirrors.

The left side of FIG. 11 shows a cross-sectional view of a movable micromirror 1101 and a plurality of electroconductive pathways 1102. The right side of FIG. 11 shows this micromirror after it has been rotated around a central axis by transmission of electrical energy 1103 through a selected subset of the electroconductive pathways. The left side of FIG. 12 shows a cross-sectional view of a movable micromirror 1201 and a plurality of electroconductive pathways 1202. The right side of FIG. 12 shows this micromirror after it has been pivoted around one end by transmission of electrical energy 1203 through a selected subset of the electroconductive pathways. The left side of FIG. 13 shows a cross-sectional view of a movable micromirror 1301, a first plurality of electroconductive pathways 1302 on one side of (e.g. distal to) the micromirror, and a second plurality of electroconductive pathways 1303 on the other side (e.g. proximal to) the micromirror. The right side of FIG. 13 shows this micromirror after it has been pivoted rotated around a central axis by transmission of electrical energy 1304 through a selected subset of the electroconductive pathways.

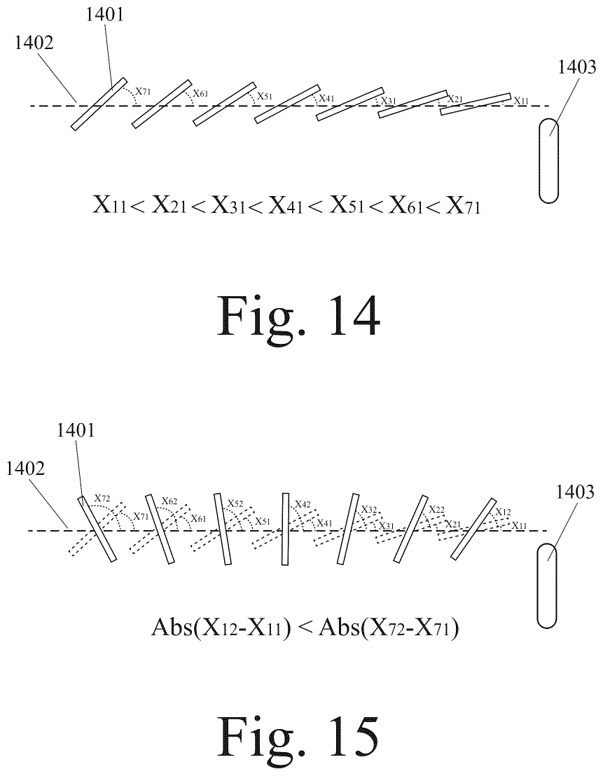

FIGS. 14 and 15 show cross-sectional views of a plurality of micromirrors (including micromirror 1401) in a micromirror array, a central plane 1402 of the micromirror array, and an optical display 1403. FIG. 14 shows this array in a virtual reality viewing mode (e.g. first configuration) in which the micromirrors block light from the environment from reaching the person's eye and reflect light from an optical display toward a person's eye to display virtual objects in the person's field of view. FIG. 15 shows this array in a real world viewing mode (e.g. second configuration) in which the micromirrors allow light from the environment to reach the person's eye and the optical display is not activated. FIGS. 14 and 15 show details concerning how the angles (e.g. relative orientations) of micromirrors vary across a micromirror array and change for different viewing modes.

In an example, the central plane of the micromirror array can be defined as the plane which best fits (e.g. minimizes the sum of squared deviations from) the centroids of micromirrors in the array. FIGS. 14 and 15 label the angles formed where micromirrors in the array intersect the central plane of the micromirror array. The angle between micromirror 1401 and the central plane is labeled X71. The first subscript for X increases (from 1 to 7 in this example) with distance from the optical display. The second subscript for X indicates whether the angle is when a micromirror is in a first configuration (shown in FIG. 14) or in a second configuration (shown in FIG. 15).

As shown in FIG. 14, the (display-facing) angle between micromirrors and the central plane of the micromirror array in virtual reality viewing mode can increase with increasing distance from the optical display. In this example, this increase is monotonic. This is represented in FIG. 14 by the expression “X11<X12<X13<X14<X15<X16<X17”. As shown in FIG. 15, the absolute value of the change in angle between micromirrors and the central plane of the micromirror array from virtual reality viewing mode to real world viewing mode can increase with increasing distance from the optical display. This is represented in FIG. 15 by the expression “Abs (X12-X11)<Abs (X72-X71)”

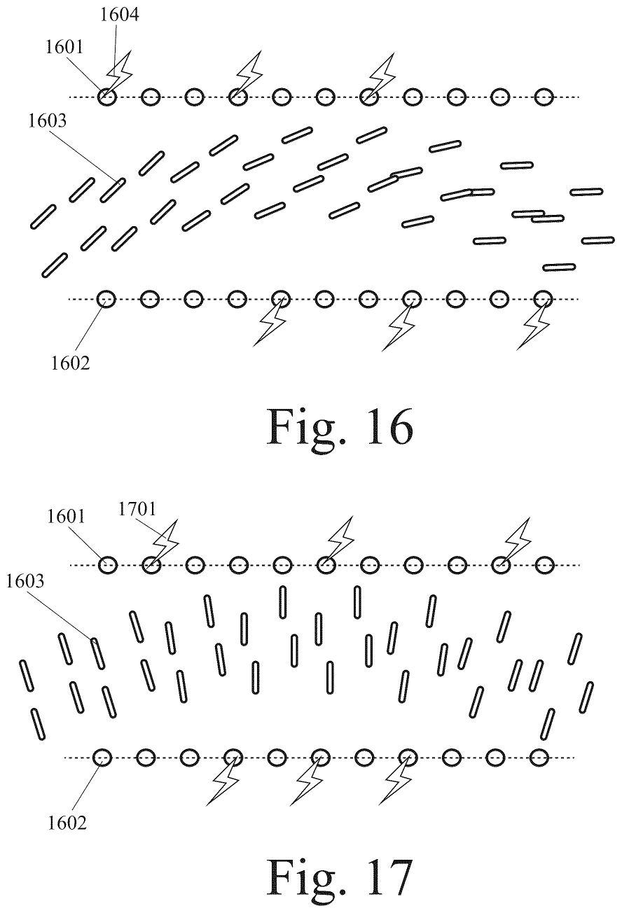

FIGS. 16 and 17 show cross-sectional views of a stacked, multilayer, and/or 3D micromirror array (including micromirror 1603) between two layers (1601 and 1602) of electroconductive pathways. FIG. 16 shows this array in a virtual reality viewing mode (e.g. first configuration) in which the micromirrors block light from the environment from reaching the person's eye and reflect light from an optical display toward a person's eye to display virtual objects in the person's field of view. FIG. 17 shows this array in a real world viewing mode (e.g. second configuration) in which the micromirrors allow light from the environment to reach the person's eye and the optical display is not activated. In FIG. 16, transmission of electrical energy 1604 through a first subset of electroconductive pathways causes (e.g. moves) the micromirrors to be in the virtual reality viewing mode (e.g. first configuration). In FIG. 17, transmission of electrical energy 1701 through a second subset of electroconductive pathways causes (e.g. moves) the micromirrors to be in the real world viewing mode (e.g. second configuration).

In an example, different individual micromirrors in the array can be selectively and independently moved by transmission of electrical energy through different electroconductive pathways. As shown in FIGS. 16 and 17, the lateral location of a selected subset of electroconductive pathways which is activated in a distal layer of pathways can differ from the lateral location of a selected subset of electroconductive pathways which is activated in a proximal layer of payments. This difference can create electromagnetic field patterns which cause micromirrors in the array to have different orientations as a function of distance from an optical display and/or the center of the array. This difference can create electromagnetic field patterns which cause micromirrors in the array to have different changes in orientation from a first to a second configuration as a function of distance from an optical display and/or the center of the array.

In an example, movable microscale reflective components can comprise micromirrors in the array. In an example, micromirrors can be rotationally-connected to axles within the micromirror array. In an example, micromirrors can be suspended within a liquid or gel within the micromirror array. In an example, micromirrors can be suspended within an electromagnetic field within the micromirror array. In an example, micromirrors in different layers of an array can be stacked, wherein the centroids of multiple micromirrors can be colinear. In an example, micromirrors in different layers of an array can be staggered, wherein the centroids of multiple micromirrors are not colinear. In an example, the angles between micromirrors and a central plane of the array can increase with increasing distance from an optical display in the first configuration and/or the second configuration.

I claim:

1. Augmented reality eyewear comprising:
an eyewear frame which is configured to be worn on a person's head;
an optical display comprising one or more light emitters which display an image;
a transparent optical component which is held in front of the person's eye by the eyewear frame;
a micromirror array in front of the person's eye, wherein the micromirror array comprises a plurality of selectively-movable micromirrors; and
an electroconductive pathway array, wherein the electroconductive pathway array comprises a plurality of selectively-activated electroconductive pathways, and wherein activation comprises transmitting electrical energy through an electroconductive pathway;
wherein the eyewear has a first configuration in which a selected subset of micromirrors in the micromirror array have a first configuration which allows light from the environment to pass through a selected portion of the transparent optical component to the person's eye;
wherein the eyewear has a second configuration in which the selected subset of micromirrors in the micromirror array have a second configuration which blocks at least some of the light from the environment from passing through the selected portion of the transparent optical component to the person's eye and reflects light from the optical display toward the person's eye in the selected portion of the transparent optical component; and
wherein the eyewear is changed from the first configuration to the second configuration by activation of a selected subset of electroconductive pathways.

2. The augmented reality eyewear in claim 1 wherein the optical display is to the right or left of the transparent optical component.

3. The augmented reality eyewear in claim 2 wherein there are vertical rows of micromirrors in the micromirror array.

4. The augmented reality eyewear in claim 1 wherein the optical display is above or below the transparent optical component.

5. The augmented reality eyewear in claim 4 wherein there are horizontal rows of micromirrors in the micromirror array.

6. The augmented reality eyewear in claim 1 wherein there are nested rings of micromirrors in the micromirror array.

7. The augmented reality eyewear in claim 1 wherein there are two or more optical displays for each eye.

8. The augmented reality eyewear in claim 7 wherein a micromirror reflects light from a first optical display toward a person's eye at a first time and reflects light from a second optical display toward the person's eye at a second time.

9. The augmented reality eyewear in claim 1 wherein the electroconductive pathway array further comprises a first layer of electroconductive pathways which is proximal to the micromirror array and a second layer of electroconductive pathways which is distal to the micromirror array.

10. The augmented reality eyewear in claim 1 wherein transmission of electrical energy through the electroconductive pathway array creates an electromagnetic field.

11. The augmented reality eyewear in claim 1 wherein micromirrors are pivoted, rotated, or oscillated by changes in an electromagnetic field.

12. The augmented reality eyewear in claim 1 wherein micromirrors are pivoted, rotated, or oscillated by electromagnetic actuators.

13. The augmented reality eyewear in claim 1 wherein micromirrors are pivoted, rotated, or oscillated by microfluidic flows.

14. The augmented reality eyewear in claim 1 wherein micromirrors are pivoted, rotated, or oscillated by sonic waves.

15. The augmented reality eyewear in claim 1 wherein micromirrors in the first configuration are parallel to lines of sight which extend out from the person's eye.

16. The augmented reality eyewear in claim 1 wherein angles between micromirrors in the second configuration and a central plane of the micromirror array vary with increasing distance from the optical display.

17. The augmented reality eyewear in claim 1 wherein micromirrors which are closer to the center of the micromirror array are smaller than micromirrors which are farther from center of the micromirror array.

18. The augmented reality eyewear in claim 1 wherein micromirrors which are closer to the center of the array are pivoted, rotated, or oscillated faster than micromirrors which are farther from the center of the array.

19. The augmented reality eyewear in claim 1 wherein micromirrors which are closer to the optical display are smaller than micromirrors which are farther from the optical display.

20. The augmented reality eyewear in claim 1 wherein the eyewear further comprises one or more other components selected from the group consisting of: camera, data processor, data receiver, data transceiver, data transmitter, electromagnetic actuators, inertial motion sensor, power source, speaker, and touch pad.
